(19) United States
(12) Patent Application Publication
(10) Pub. No.: US 2015/0091832 A1
(43) Pub. Date: Apr. 2, 2015

(54) INFORMATION PROCESSING APPARATUS, INFORMATION PROCESSING METHOD, AND PROGRAM

(71) Applicant: SONY CORPORATION, Tokyo (JP)

(72) Inventors: HIROYUKI MIZUNUMA, TOKYO (JP); KENTARO IDA, TOKYO (JP); YOSHIYUKI KOBAYASHI, TOKYO (JP); IKUO YAMANO, TOKYO (JP)

(21) Appl. No.: 14/494,768

(22) Filed: Sep. 24, 2014

(30) Foreign Application Priority Data
Oct. 2, 2013 (JP) 2013-206928

(51) Int. Cl. G06F 3/0354; G06F 3/041

(52) U.S. Cl. CPC G06F 3/03545; G06F 3/041
USPC 345/173

(57) ABSTRACT

An information processing apparatus includes a data processing unit which performs track calculation processing in accordance with input position information, and the data processing unit executes predicted track calculation processing for calculating a predicted track of a region for which the track calculation in accordance with the input position information has not been completed, and calculates the predicted track by using a dynamic prediction method in the predicted track calculation processing.

### CROSS REFERENCE TO RELATED APPLICATIONS

This application claims the benefit of Japanese Priority Patent Application JP 2013-206928 filed Oct. 2, 2013, the entire contents of which are incorporated herein by reference.

### BACKGROUND

The present disclosure relates to an information processing apparatus, an information processing method, and a program. Specifically, the present disclosure relates to an information processing apparatus, an information processing method, and a program which reduce a delay in displaying a depicted line on a touch panel-type display, for example.

In recent years, touch-panel-type input display apparatuses have been used in many cases. A touch panel-type input display apparatus is an apparatus capable of performing information display processing by using a liquid crystal display, for example, and inputting information by touching a display surface with a finger or a pen.

A position, which is touched with the finger or the pen, in the display surface can be detected, and processing in accordance with the detected position, such as depiction processing, can be performed. In addition, there are various methods for detecting the position of the pen or the finger, for example, an electromagnetic induction method and electrostatic capacity method.

However, when a pen, for example, is used as an input device and a line in accordance with a track of the pen is depicted by such an apparatus, “deviation” occurs between a position of a pen tip and a position of a leading end of a displayed line on the display in some cases. This is caused by a delay in processing time between the pen position detection processing and the line depiction processing, and the deviation significantly appears when the pen is moved at a high speed.

As a technology in related art, Japanese Unexamined Patent Application Publication No. 9-190275 discloses a configuration for solving such deviation. Japanese Unexamined Patent Application Publication No. 9-190275 discloses a configuration in which a static filter (function) is used to predict an unprocessed subsequent track and depiction is performed.

According to the disclosed method, a linear approximation straight line is generated by using the newest track region from a track which has already been detected, and the generated linear approximation straight line is extended as a track of the unprocessed (undepicted) part and is then displayed. According to the method, it is also possible to generate an approximation curve by changing a setting of a degree of approximation or by using a trigonometric function.

However, according to the disclosed method, only processing of predicting the subsequent track by the approximation processing using only the last depicted track immediately before the unprocessed region is performed, and there is a case where overshoot of a prediction point or a significant difference between the actual position of the pen tip and the prediction point occurs when a speed or a direction suddenly changes, for example.

### SUMMARY

It is desirable to provide an information processing apparatus, an information processing method, and a program which reduces a positional difference between a position of an input device and a depiction position and realizes more accurate depiction processing.

According to a first embodiment of the present disclosure, there is provided an information processing apparatus including: a data processing unit which performs track calculation processing in accordance with input position information, wherein the data processing unit executes predicted track calculation processing for calculating a predicted track of a region for which the track calculation in accordance with the input position information has not been completed, and calculates the predicted track by using a dynamic prediction method in the predicted track calculation processing.

According to the information processing apparatus of the embodiment, the dynamic prediction method may be a method of performing track prediction to which track information previous to the last track of a depicted track is applied.

According to the information processing apparatus of the embodiment, in the predicted track calculation processing, a plurality of similar tracks which are similar to the last track immediately before the region for which the predicted track is to be calculated may be detected from the past track, and the predicted track may be calculated based on the detected plurality of similar tracks.

According to the information processing apparatus of the embodiment, in the predicted track calculation processing, following tracks of the respective similar tracks may be estimated based on the detected plurality of similar tracks, and the predicted track may be calculated by averaging processing or weighted addition processing of the estimated plurality of following tracks.

According to the information processing apparatus of the embodiment, in the processing of detecting the similar tracks which are similar to the last track, the data processing unit may compare feature amounts of tracks and select track regions with feature amounts which are similar to that of the last track as similar tracks.

According to the information processing apparatus of the embodiment, the feature amount may include at least one of a speed, acceleration, an angle, and an angular difference of the track.

According to the information processing apparatus of the embodiment, the feature amount may include all the speed, the acceleration, the angle, and the angular difference of the track.

According to the information processing apparatus of the embodiment, the feature amount may include at least one of a value of pressure, which is a pressure of writing by an input device, and an amount of variation in the value of pressure.

According to the information processing apparatus of the embodiment, the feature amount may include all the speed, the acceleration, the angle, the angular difference, and the value of pressure of the track.

According to the information processing apparatus of the embodiment, in the processing of detecting the similar tracks which are similar to the last track, the data processing unit may calculate, as feature amount distance data, weighted addition data of differences between speeds, acceleration, angles, and angular differences of the last track and of comparison target tracks in the past, and select tracks in the past, which have small feature amount distance data, as similar tracks.

According to the information processing apparatus of the embodiment, in the feature amount distance data calculation processing in the processing of detecting the similar tracks which are similar to the last track, the data processing unit may execute the feature amount distance data calculation processing in which a weight in accordance with a distance is set such that tracks which are close to the last track, in terms of the distance therefrom, are selected with priority.

According to the information processing apparatus of the embodiment, in the processing of estimating the following tracks of the respective similar tracks based on the plurality of similar tracks, the data processing unit may estimate speeds, angles, and coordinates of the following tracks corresponding to the respective similar tracks by applying information on speeds, angles, and coordinate positions of the newest positions of the respective similar tracks, and calculate coordinates which configure the predicted track by averaging processing or weighted addition processing of the estimated coordinates of the following tracks corresponding to the respective similar tracks.

According to the information processing apparatus of the embodiment, in the weighted addition processing of the estimated coordinates of the following tracks corresponding to the respective similar tracks, the data processing unit may calculate the coordinates which configure the predicted track by executing processing in which a weight for coordinates of a following track corresponding to a similar track with higher similarity with respect to the last track is set to be larger.

According to the information processing apparatus of the embodiment the data processing unit may calculate reliability of the predicted track in accordance with a degree of distribution in the estimated coordinates of the following tracks corresponding to the respective similar tracks, and in a case where the reliability is determined to be low, stop an output of the predicted track to a display unit.

According to the information processing apparatus of the embodiment, the data processing unit may calculate standard deviation of the coordinates of the following tracks corresponding to the respective similar tracks as an index value of the reliability.

According to the information processing apparatus of the embodiment, the data processing unit may execute predicted track estimation processing to which a k nearest neighbors (kNN) method is applied.

According to the information processing apparatus of the embodiment, in the predicted track calculation processing, the data processing unit may calculate the predicted track based on information of a track which is depicted before a track being currently displayed.

According to a second embodiment of the present disclosure, there is provided an information processing method which is executed by an information processing apparatus including a data processing unit which performs track calculation processing in accordance with input position information, the method including: causing the data processing unit to execute predicted track calculation processing for calculating a predicted track of a region for which the track calculation in accordance with the input position information has not been completed; and calculating the predicted track by using a dynamic prediction method in the predicted track calculation processing.

According to a third embodiment of the present disclosure, there is provided a program which causes an information processing apparatus to execute information processing, the program including: causing a data processing unit to execute track calculation processing in accordance with input position information; causing the data processing unit to execute predicted track calculation processing for calculating a predicted track of a region for which the track calculation in accordance with the input position information has not been completed; and calculating the predicted track by using a dynamic prediction method in the predicted track calculation processing.

In addition, the program according to the embodiment of the present disclosure is a program which can be provided to an image processing apparatus or a computer system, which is capable of executing various program codes, for example, by a storage medium or a communication medium in a computer readable form. By providing the program in the computer readable form, processing in accordance with the program is implemented on the information processing apparatus or the computer system.

Other purposes, features, advantages of the present disclosure will become apparent from a further detailed description based on embodiments and accompanying drawings of the present disclosure, which will be given below. In addition, a system described herein is a logical integrated configuration of a plurality of devices, and the devices with the respective configurations are not necessarily provided in the same case body. With the configurations according to the embodiments of the present disclosure, precise track prediction processing based on past track information is realized.

Specifically, the data processing unit which performs the track calculation processing based on the input position information is provided to execute the predicted track calculation processing on a region for which the track calculation based on the input position information has not been completed. First, the plurality of similar tracks which are similar to the last track of the predicted track calculation region are detected from the past track based on the feature amounts such as speeds, acceleration, angles, and angular differences. Furthermore, the following tracks of the respective similar tracks are estimated based on the plurality of detected similar tracks. Furthermore, the predicted track is calculated by the averaging processing or the weighted addition processing of the plurality of estimated following tracks. With such a configuration, precise track prediction processing based on the past track information is realized.

In addition, the effects are described herein only for an illustrative purpose and are not intended to limit the effects of the present disclosure, and additional effects may be achieved.

### BRIEF DESCRIPTION OF THE DRAWINGS

FIG. 1 is a diagram illustrating a problem which occurs when a line segment (line) is depicted on an input display apparatus by using a pen-type input device;

FIGS. 2A and 2B are diagrams illustrating examples in which prediction errors occur in a predicted track depiction processing;

FIG. 3 is a diagram illustrating track prediction processing which is executed by an information processing apparatus according to the present disclosure;

FIG. 4 is a diagram illustrating an outline of the track prediction processing which is executed by the information processing apparatus according to the present disclosure;

FIG. 5 is a flowchart illustrating a sequence of predicted track estimation and depiction processing to which a kNN method is applied;

FIG. 6 is a diagram illustrating a specific example of the predicted track estimation and depiction processing to which the kNN method is applied;

FIG. 7 is a diagram illustrating feature amounts which are applied to the predicted track estimation;

FIG. 8 is a diagram illustrating an example of similar track extraction processing;

FIG. 9 is a diagram illustrating reliability of the predicted track;

FIG. 10 is a flowchart illustrating sequences of standard deviation calculation processing and predicted track calculation and depiction processing which includes a processing change in accordance with a processing result;

FIG. 11 is a diagram showing an example of a plurality of (k) auxiliary predicted tracks and standard deviation of the respective coordinate positions of the auxiliary predicted tracks which are applied to predicted track determination processing;

FIG. 12 is a diagram showing an example of reliability calculation for the respective future frames U=t+1, t+2, and t+3;

FIG. 13 is a diagram illustrating a specific example of predicted track display control;

FIG. 14 is a diagram illustrating the specific example of the predicted track display control;

FIG. 15 is a diagram illustrating a specific example of display control in accordance with reliability of the predicted track;

FIG. 16 is a diagram illustrating the specific example of the display control in accordance with reliability of the predicted track;

FIGS. 17A and 17B are diagrams illustrating an example of processing of deleting a displayed predicted track and depicting a new predicted track in a next depiction frame;

FIG. 18 is a diagram illustrating processing of not depicting the last predicted track immediately before a prediction point when a reliability index point is not less than a predetermined threshold value;

FIG. 19 is a diagram illustrating an example of processing of switching between ON and OFF of predicted track depiction, namely switching between display and non-display in accordance with a situation;

FIG. 20 is a diagram illustrating processing of detecting that an amount of decrease in a value of pressure of an input device per a unit time is equal to or greater than a prescribed threshold value [Thp];

FIG. 21 is a diagram illustrating an example of processing of detecting that a moving amount of the input device per a unit time is less than a prescribed threshold value [Thd];

FIGS. 22A and 22B are diagrams illustrating an example of processing of controlling the predicted track to appear less outstandingly by changing a predicted track display state in a case where the predicted track deviates from an actual track;

FIG. 23 is a flowchart illustrating a sequence of predicted track display control processing;

FIG. 24 is a flowchart illustrating a sequence of predicted track display control processing;

FIGS. 25A and 25B are diagrams illustrating an example of effects by display of the predicted track; and

FIG. 26 is a diagram illustrating a hardware configuration example of the information processing apparatus according to the present disclosure.

### DETAILED DESCRIPTION OF EMBODIMENTS

Hereinafter, a detailed description will be given of an information processing apparatus, an information processing method, and a program according to the present disclosure with reference to the drawings. In addition, the description will be given based on the following points.

1. Concerning Problems in Depiction Processing

2. Concerning Track Prediction Processing Executed by Information Processing Apparatus According to Present Disclosure

3. Concerning Example of Prediction Processing Using Depicted Track Coordinate Information

3-1. Concerning Similarity Determination Processing

3-2. Concerning Predicted Track Determination Processing

4. Concerning Example of Processing in Accordance with Reliability of Predicted Track

5. Concerning Processing to Which Input Device Pressure Detection Information Is Applied

6. Concerning Modification Example of Predicted Track Calculation and Depiction Processing

7. Concerning Example in Which Predicted Track Depiction State Is Controlled

8. Concerning Sequence of Predicted Track Display Control Processing

9. Concerning Example of Effects by Precise Predicted Track Display

10. Concerning Hardware Configuration Example of Information Processing Apparatus According to Present Disclosure

11. Conclusion of Configuration According to Present Disclosure

1. Concerning Problems in Depiction Processing

First, a description will be given of problems which occurs when depiction is performed on an input display apparatus by using an input device (input object) such as a touch pen.

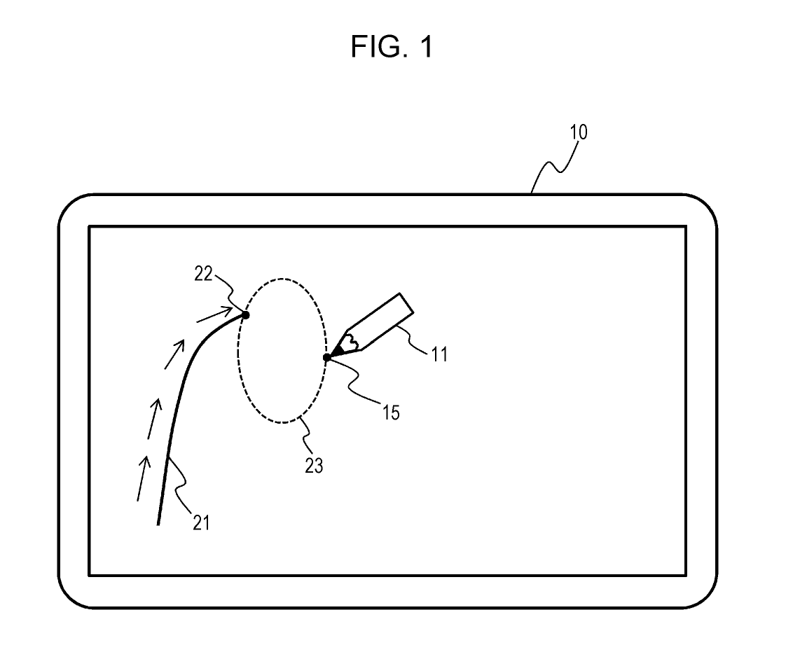

FIG. 1 is a diagram showing an example in which a line segment (line) is depicted on a touch panel-type input display apparatus 10 by using a pen-type input device 11. The input device 11 sequentially moves in the arrow direction, and a track based on the track of the input device 11 is depicted. That is, a line as the track of the input device is displayed.

However, if a moving speed of the input device 11 is high, the track depiction processing does not follow the moving speed of the input device 11, and the display of the track line segment is delayed.

A depicted track 21 shown in the drawing is a line which is displayed on the display in accordance with the track of the input device. The newest depiction position 22 of the depicted track 21 does not coincide with a current pen tip position 15 of the input device 11 and is located at a position of the track of the input device 11, at which the depiction is performed earlier by a predetermined period. A depiction delay region 23 shown in the drawing is a blank region where display of a line (line segment) in accordance with a track does not catch up though the pen has already moved in accordance with a predetermined track. Such a blank region is generated due to the delay of the depiction processing.

As processing to eliminate such a blank region, there is processing using a static filter (function) described in the above section of “BACKGROUND”. This is processing of predicting and depicting a subsequent line by linear approximation or the like using a line region with a predetermined length including the newest depiction position 22 of the depicted track 21 shown in FIG. 1, for example.

That is, a linear approximation straight line is generated from the newest depicted part of the depicted track, and a line corresponding to a predicted track is depicted by extending the linear approximation straight line after the newest depiction position 22 as described above. However, if such processing is performed, there is a case where a predicted track which is different from an actual track of the pen is generated and the track is erroneously depicted.

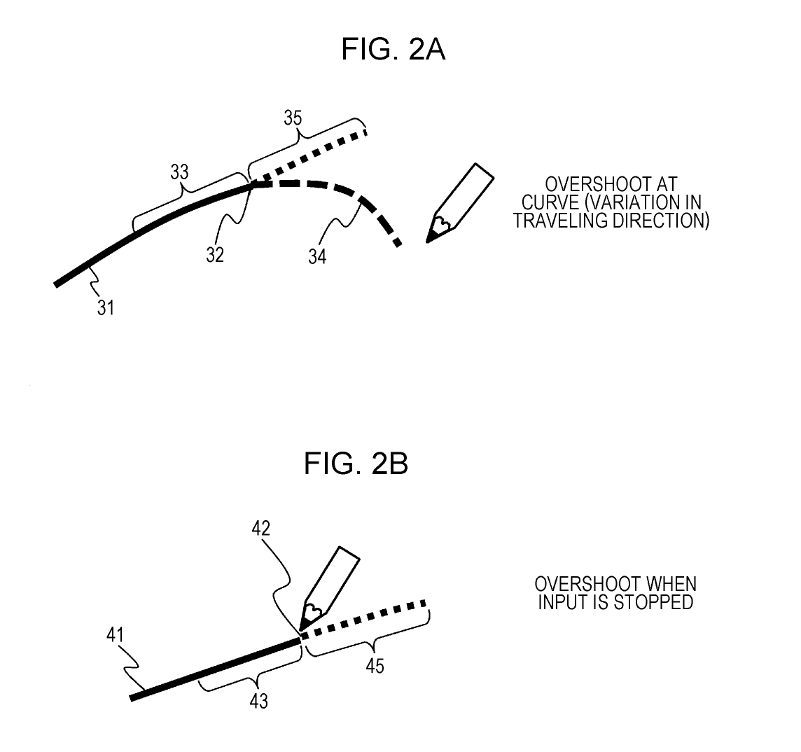

A description will be given of an example in which such a prediction error occurs with reference to FIGS. 2A and 2B. FIGS. 2A and 2B show two examples of prediction errors. FIG. 2A shows a first example of a prediction error due to overshoot which is caused when a track of the pen is suddenly curved and a pen traveling direction greatly varies.

At the newest depiction position 32 of a depicted line 31, the traveling direction of the pen suddenly varies as shown by a pen track 34 in the drawing. However, in the case of performing the aforementioned prediction processing using the static filter (function), the data used for the prediction is only the predicted track with the predetermined length, which includes the newest depiction position 32 of the depicted track 31. That is, only an approximation applied track 33 shown in the drawing is the data applied to the prediction.

For example, a line which is extended in accordance with a line direction of the approximation applied track 33 is set and displayed as a predicted track 35. As a result, the predicted track 35 is set at a position which is completely different from a position of the actual pen track 34 as shown in the drawing.

As another example of a prediction error, FIG. 2B shows the second example of a prediction error, in which a pen as an input device is suddenly stopped. The drawing shows an example of processing which is performed in a case where the pen stops moving at the newest depiction position 42 of the depicted track 41.

In the case of performing the aforementioned prediction processing using the static filter (function), data used for the prediction is the depicted line with the predetermined length, which includes the newest depiction position 42 of the depicted track 41. An approximation applied track 43 shown in the drawing is data applied to the prediction.

A line extend in accordance with a line direction of the approximation applied track 43 is set as a predicted track 45. As a result, the predicted track 45 is set so as to precede the actual position of the pen as shown in the drawing. The line segment prediction processing using the static filter (function) is processing in which the last line segment of the depicted track is applied to the approximation processing as described above. Therefore, if a pen moving state is different from that of the approximation applied track, a prediction result which is completely different from the actual track of the pen is obtained, and an erroneously predicted track is displayed.

2. Concerning Track Prediction Processing Executed by Information Processing Apparatus According to Present Disclosure

Next, a description will be given of an example of track prediction processing which is executed by the information processing apparatus according to the present disclosure.

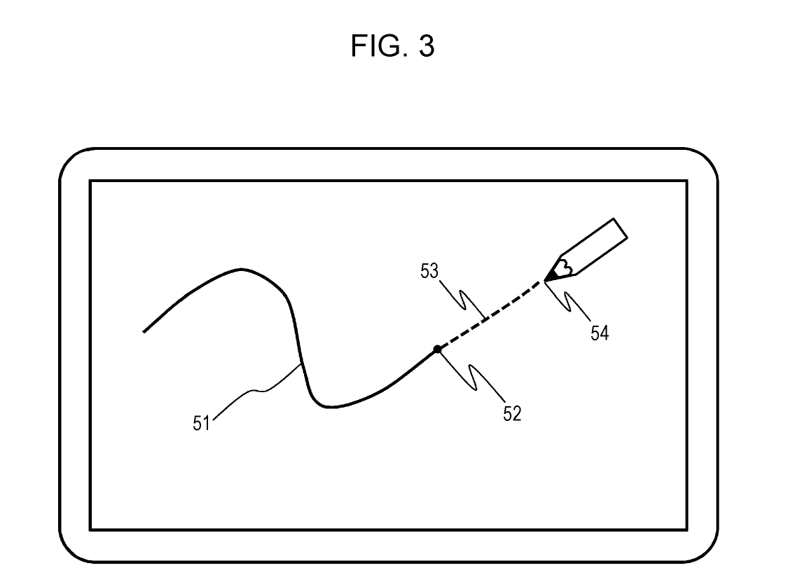

FIG. 3 is a diagram showing an example of the track prediction processing which is executed by the information processing apparatus according to the present disclosure. By applying the processing of the information processing apparatus according to the present disclosure, it is possible to precisely estimate and display a predicted track 53, which is a predicted line from the newest depiction position 52 of a depicted track 51 to a pen position 54. By the precise processing of estimating and displaying the predicted track 53, it is possible to reduce a sensation of a delay, which is felt by a user, and to implement depiction processing which does not cause an uncomfortable feeling.

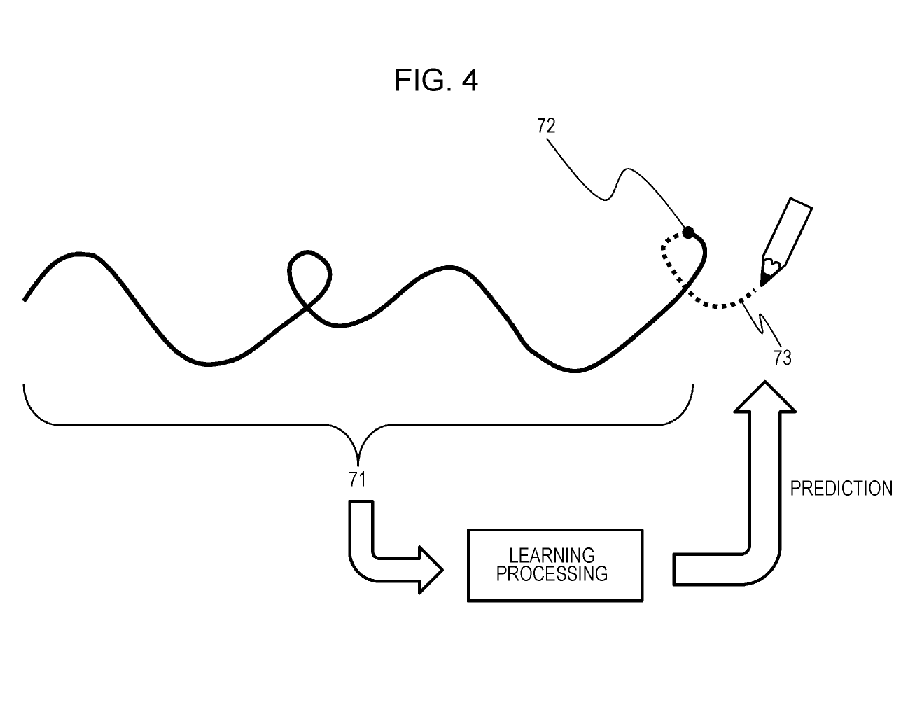

FIG. 4 is a diagram illustrating an outline of the track prediction processing executed by the information processing apparatus according to the present disclosure. According to the embodiment, depiction processing is performed by executing learning processing (mechanical learning) to which information on a configuration of a depicted track 71 is applied and applying a result of the learning to set a predicted track 73.

The predicted track 73 is depicted after the newest depiction position 72. According to the embodiment, the predicted track is estimated by the learning processing using not only on the information on the last depicted track immediately before the newest depiction position but also information on a past depicted track. By the processing, the prediction error as described above with reference to FIGS. 2A and 2B is reduced, and precise prediction is realized.

The track prediction processing which is executed by the information processing apparatus according to the present disclosure is dynamic prediction processing which is different from the aforementioned static prediction in the related art, in which the fixed static filter (function) is used.

In addition, the static prediction is processing in which the last line segment of the depicted track is applied to the approximation processing, and further, the past track information does not affect the predicted track. Therefore, in the case where the last track applied to the prediction is constant, the predicted track becomes a constant track.

In contrast, according to the dynamic prediction, track prediction is performed with reference to track information previous to the last line segment of the depicted track, and the past track affects the predicted track. Therefore, if past tracks are different even when the last track applied to the prediction is constant, predicted tracks are differently obtained.

In addition, the past track includes a track before the last track and includes a track which is not displayed on a display unit. Hereinafter, a description will be given of predicted track estimation processing by the learning processing, to which a k nearest neighbors (kNN) method is applied, as an example of the learning processing which is applied in the embodiment.

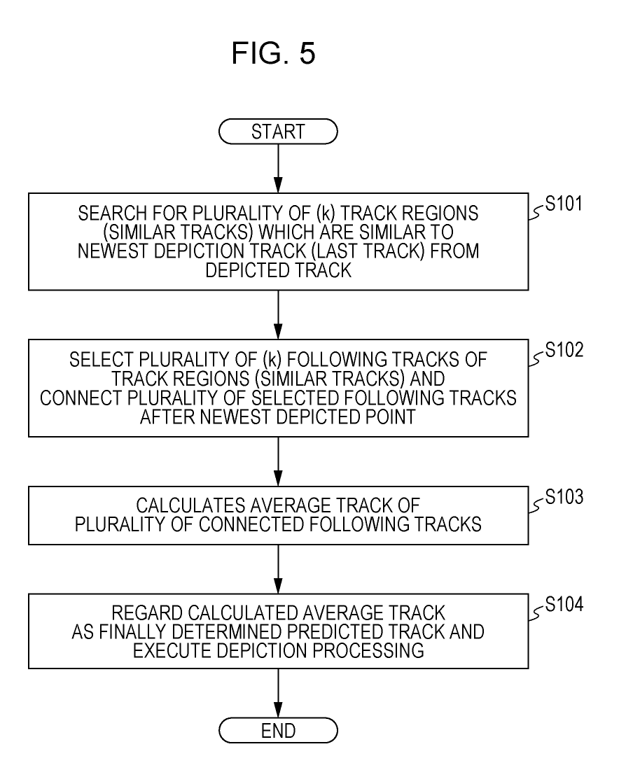

FIG. 5 is a flowchart illustrating a sequence of predicted track estimation and depiction processing to which the kNN method is applied. The processing shown in the flowchart is executed under control by a data processing unit, specifically a data processing unit configured of a CPU or the like with a program executing function, for example, in the information processing apparatus according to the present disclosure. The program is stored on a memory, for example, in the information processing apparatus.

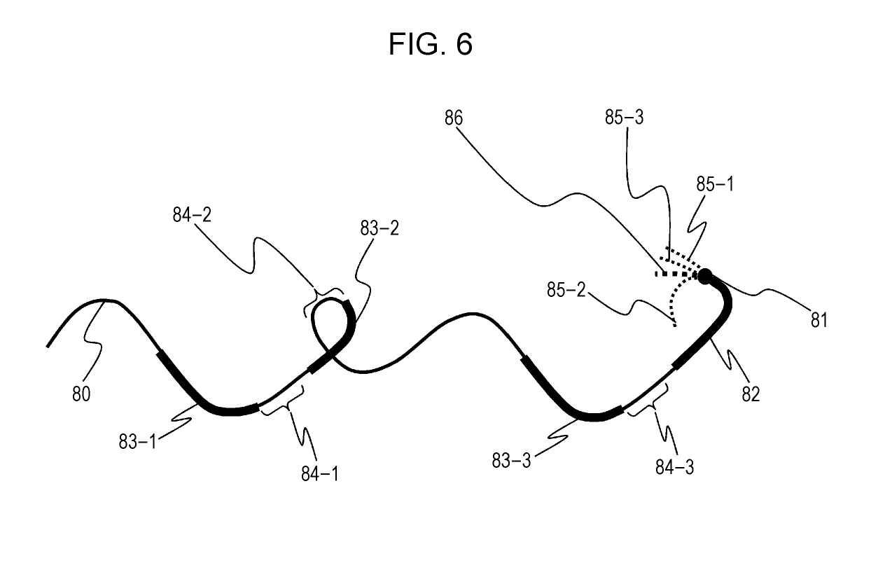

First, a sequential description will be given of processing in the respective steps in the flow shown in FIG. 5, and thereafter, a description will be given of specific examples of the processing in the respective steps with reference to FIG. 6. In addition, the information processing apparatus performs processing of depicting a line in accordance with a track of an input device (input object) such as a dedicated pen (stylus).

However, a depiction delay region in which the depiction processing does not catch up is generated in the last region immediately before a current position of the input device (dedicated pen) as described above with reference to FIG. 1 and the like. The flow in FIG. 5 shows a sequence of processing of depicting a line along an estimated track, which is obtained by estimating a track of the input device in the depicted delay region, as a predicted track. The flow shows estimation and depiction processing of estimating and depicting the predicted track 73 shown in FIG. 4, for example.

Step S101

First, a plurality of (k) track regions (similar tracks) which are similar to the newest depicted track (last track) are searched for from the depicted track in Step S101. The depicted track corresponds to a track region, for which input device track analysis has been completed and the processing of depicting a line in accordance with the track, namely the processing of outputting the track to the display unit and displaying the track on the display has been completed.

The newest depicted track (last track) corresponds to the newest track region of the depicted track and corresponds to a track region which is in contact with a depiction delayed part. Specifically, the last track corresponds to the depicted region with the predetermined length, which includes the newest depiction position 72 shown in FIG. 4. In Step S101, a plurality of (k) track regions (similar tracks) which are similar to the newest depicted track (last track) are searched for from the depicted track. k is a prescribed value such as 3, 5, 10, 20, or 30.

If it is difficult to search for the predetermined k similar tracks, for example, in a depiction initial stage, a configuration is also applicable in which processing using only searched similar tracks is performed or the estimation processing is stopped.

Step S102

Next, in Step S102, the following tracks of the plurality of (k) track regions (similar tracks) searched for in Step S101 are estimated or selected, and the plurality of following tracks are connected after the newest depiction position. The newest depiction position corresponds to the newest depiction position 72 in the example shown in FIG. 4.

Step S103

Next, in Step S103, an average track of the plurality of connected following tracks is calculated.

Step S104

Finally, in Step S104, processing of depicting the average track calculated in Step S103 as a finally determined predicted track is executed. A description will be given of a specific example of processing in accordance with the flow shown in FIG. 5, with reference to FIG. 6. FIG. 6 shows the same depicted line as that shown in FIG. 4. The drawing shows an example in which the input device such as a dedicated pen depicts a track from the left to the right and the line along the track is depicted.

The dedicated pen as the input device travels so as to precede the newest depiction position 81 of the depicted track, and a predicted track based on an estimated track is determined and depicted after the newest depiction position 81. In the example shown in FIG. 6, the finally set predicted track is a finally determined predicted track (Qf) 86 shown in FIG. 6. The finally determined predicted track (Qf) 86 is determined by processing of averaging k auxiliary predicted tracks Q1 to Q3 which are set in accordance with the k extracted similar tracks. A description will be given of processing in Steps S101 to S104 in FIG. 5 with reference to FIG. 6.

Step S101

First, in Step S101, a plurality of (k) track regions (similar tracks) which are similar to the newest depicted track (last track) are searched for from the depicted track. A description will be given of the processing with reference to the example shown in FIG. 6.

First, the newest depicted track (last track P) 82 is extracted from a depicted track 80 shown in FIG. 6. Furthermore, a plurality of (k) track regions which are similar to the extracted newest depicted track (last track P) 82 are searched for from the depicted track.

FIG. 6 shows an example in which k=3 and the following three similar tracks (Rn) of the last track (P) are searched for:

a similar track (R1) 83-1 of the last track (P);

a similar track (R2) 83-2 of the last track (P);and

a similar track (R3) 83-3 of the last track (P).

The processing in Step S101 is processing of searching for the k similar tracks, which are similar to the newest depicted track (last track P) 82, from the depicted track as described above.

Step S102

Next, in Step S102, the following tracks of the plurality of (k) track regions (similar regions) which are searched for in Step S101 are selected, and the plurality of selected following tracks are connected after the newest depiction position. A description will be given of the processing with reference to the example shown in FIG. 6.

In Step S101, the three similar tracks shown in FIG. 6, that is:

the similar track (R1) 83-1 of the last track (P);

the similar track (R2) 83-2 of the last track (P); and

the similar track (R3) 83-3 of the last track (P) are searched for.

In Step S102, the following tracks of these similar tracks are selected.

In the example shown in FIG. 6, the following three following tracks are selected:

the following track (A1) 84-1 of the similar track (R1);

the following track (A2) 84-2 of the similar track (R2); and

the following track (A3) 84-3 of the similar track (R3).

Furthermore, the three following tracks 84-1 to 84-3 are connected after the newest depiction position 81. In addition, angles between the last track P and the following tracks to be connected are angles which coincide with connection angles between the following angles to be connected to the similar tracks corresponding to the following tracks.

As described above, the three following tracks A1 to A3 are connected to the newest depiction position 81 as shown in FIG. 6. The respective connected tracks are the following three auxiliary predicted tracks as shown in FIG. 6:

an auxiliary predicted track (Q1) 85-1 corresponding to the following track (A1);

an auxiliary predicted track (Q2) 85-2 corresponding to the following track (A2); and

an auxiliary predicted track (Q3) 85-3 corresponding to the following track (A3).

The processing in Step S102 is processing in which the following tracks of the similar tracks detected in Step S101 are connected after the newest depiction position.

Step S103

Next, in Step S103, an average track of the plurality of connected following tracks is calculated.

A description will be given of the processing with reference to FIG. 6. In FIG. 6, the following tracks connected after the newest depiction position 81 are the following three auxiliary predicted tracks:

the auxiliary predicted track (Q1) 85-1 corresponding to the following track (A1);

the auxiliary predicted track (Q2) 85-2 corresponding to the following track (A2); and

the auxiliary predicted track (Q3) 85-3 corresponding to the following track (A3).

In Step S103, an average track of the three auxiliary predicted tracks (Q1 to Q3) 85-1 to 85-3 is calculated. As a result, the obtained average track is a track as shown as the finally determined predicted track (Qf) 86 shown in FIG. 6.

Step S104

Finally, in Step S104, processing of depicting the average track calculated in Step S103 as a finally determined predicted line (finally determined predicted track) is executed. A description will be given of the processing with reference to FIG. 6.

In Step S104, processing of depicting the average track calculated in Step S103, namely the finally determined predicted track (Qf) 86 shown in FIG. 6 as a predicted track is executed.

3. Concerning Example of Prediction Processing Using Depicted Track Coordinate Information

Processing in accordance with the flow shown in FIG. 5 can be executed by using coordinate information (xₜ, yₜ) of a depicted track which is updated in each image frame (t) displayed on the display unit of the information processing apparatus.

Hereinafter, a description will be given of the predicted track determination processing by using the coordinate information.

The information processing apparatus stores, on a memory, the coordinate information (xₜ, yₜ) of the depicted track which is newly displayed in units of image frames (t) displayed on the display unit, for example. The information processing apparatus stores, on the memory, coordinate information corresponding to a track depicted for a predetermined period in the past from the newest depiction position and uses the coordinate information to execute track similarity determination processing, following track connection processing, and further final predicted track determination processing by calculating an average value of the connected following tracks.

In addition, the coordinate information (x, y) is associated with each display frame (t) and stored on the memory. For example, coordinates indicating the newest depicted track position corresponding to a frame t is stored as (xₜ, yₜ) on the memory. Coordinates indicating the newest depicted track position corresponding to the next frame t+1 is stored as (xₜ₊₁, yₜ₊₁) on the memory. As described above, the coordinate information as track position information associated with each frame is stored on the memory and is used to execute track similarity determination processing and the like.

Hereinafter, a description will be given of a specific example of the processing by using the track coordinate information.

3-1. Concerning Similarity Determination Processing

In Step S101 described above with reference to the flow shown in FIG. 5, processing of searching for the newest depicted track (last track) and the similar tracks from the depicted track is performed. In the similarity determination processing, feature amounts of the track are calculated by using the track coordinate information and are compared to determine the similarity.

As the feature amounts applied to the similarity determination, the following feature amounts are calculated, for example:

(1) a speed: Z1;

(2) acceleration: Z2;

(3) an angle: Z3; and

(4) an angular difference: Z4.

The respective feature amounts are calculated by using the coordinate information corresponding to the depicted track. Furthermore, a feature amount calculated from the coordinate information configuring the newest depicted track (last track) is compared with a feature amount calculated from the coordinate information configuring the depicted track, and regions of depicted tracks with more similar feature amounts are extracted as similar tracks. By such processing, similar tracks (R1 to R3) 84-1 to 84-3 shown in FIG. 6, for example, are extracted.

Equations for calculating the respective feature amounts Z1 to Z4 will be shown below.

Z1(t)=sqrt{(xₜ−xₜ₋₁)²+(yₜ−yₜ₋₁)²} (1) speed:

Z2(t)=sqrt{(xₜ−xₜ₋₁)²+(yₜ−yₜ₋₁)²}sqrt{(xₜ₋₁−xₜ₋₂)²+(yₜ₋₁−yₜ₋₂²} (2) acceleration:

Z3(t)=atan{(x₁−xₜ₋₁)/(yₜ−yₜ₋₁)} (3) angle:

Z4(t)=atan{(xₜ−xₜ₋₁)/(yₜ−yₜ₋₁)}−atan{(xₜ₋₁−xₜ₋₂)/(yₜ₋₁−yₜ₋₂)} (4) angular difference:

In addition, Z1(t) represents a speed in the frame t, Z2(t) represents acceleration in the frame t, Z3(t) represents an angle in the frame t, and Z4(t) represents an angular difference in the frame t. In addition, sqrt represents a square root, and atan represents an arc tangent.

In addition, t is a parameter which represents a frame number in the embodiment, it is also possible to perform processing in which t is set as time information instead of the frame number. That is, it is possible to replace the frame t and the frame u with time t and time u in the following description.

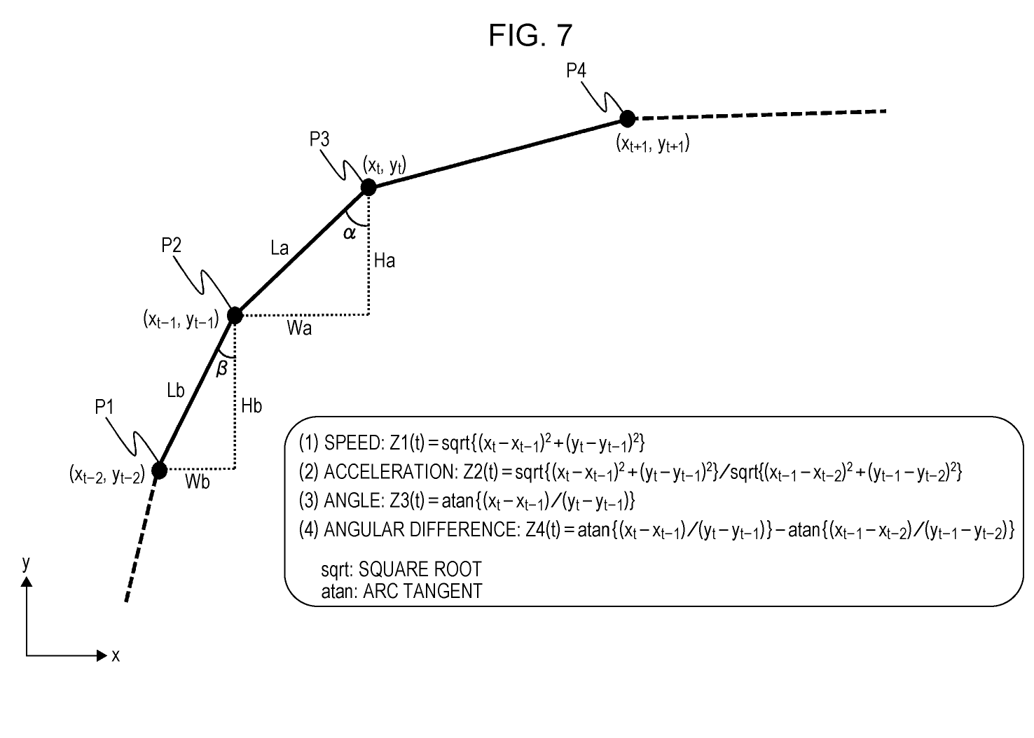

A description will be given of the feature amounts Z1 to Z4 with reference to FIG. 7. FIG. 7 shows a part of the depicted track. In the drawing, coordinates (xₜ₋₂, yₜ₋₂) to (xₜ₊₁, yₜ₊₁) of the newest position of the depicted track when the respective frames t−2 to t+1 are displayed on the display unit. That is, the following four points P1 to P4 are shown.

As shown in the lower left part in FIG. 7, x corresponds to the horizontal direction, and y corresponds to the vertical direction of the drawing.

P1: coordinates (x_{t-z}, yₜ₋₂) of the newest position of the depicted track displayed in the frame t−2

P2: coordinates (xₜ₋₁, yₜ₋₁) of the newest position of the depicted track displayed in the frame t−1

P3: coordinates (xₜ, yₜ) of the newest position of the depicted track displayed in the frame t

P4: coordinates (xₜ₊₁, yₜ₊₁) of the newest position of the depicted track displayed in the frame t+1

The aforementioned feature amounts Z1(t) to Z4(t) are calculated as feature amounts corresponding to the coordinates (xₜ, yₜ) corresponding to the frame t.

The feature amounts are similarly calculated at coordinate positions corresponding to the respective frames other than the frame t.

Concerning Speed Z1(t)

The speed Z1(t), which is one of the feature amounts corresponding to the newest coordinates (xₜ, yₜ) in the frame t, is calculated by the following equation.

Z1(t)=sqrt{(xₜ−xₜ₋₁)²+(yₜ−yₜ₋₁)²} Speed:

This corresponds to a distance La between P3(xₜ, yₜ) and P2(xₜ₋₁, yₜ₋₁) shown in FIG. 7.

That is, the value represents a distance by which the track advances between the frame t−1 to the frame t and corresponds to a track moving speed in one frame.

Concerning Acceleration Z2(t)

The acceleration Z2(t), which is one of the feature amounts corresponding to the newest coordinates (xₜ, yₜ) in the frame t, is calculated by the following equation.

Z2(t)=sqrt{(xₜ−xₜ₋₁)²+(yₜ−yₜ₋₁²}/sqrt{(xₜ₋₁−xₜ₋₂)²+(yₜ₋₁−yₜ₋₂)²} Acceleration:

This corresponds to a ratio La/Lb between the distance La from P3(xₜ, yₜ) and P2(xₜ₋₁, yₜ₋₁) and a distance Lb from P2(xₜ₋₁, yₜ₋₁) and P1(xₜ₋₂, yₜ₋₂) shown in FIG. 7.

That is, the distance La by which the track advances from the frame t−1 to the frame t is a value which is several times the distance Lb by which the track advances from the frame t−2 to the frame t−1, and corresponds to a magnification between the track moving speed in the current frame and the track moving speed in the preceding frame.

Although the feature amount Z2(t) representing the acceleration is calculated as a magnification of the speed, which represents how many times the later speed is as high as the former speed, the feature amount Z2(t) may be calculated as a difference between the later speed and the former speed.

In such a case, the feature amount Z2(t) is calculated by the following equation.

Z2(t)=sqrt{(xₜ−xₜ₋₁)²+(yₜ−yₜ₋₁)²}−sqrt{(xₜ₋₁−xₜ₋₂)²+(yₜ₋₁−yₜ₋₂)²} Acceleration:

This corresponds to a difference La−Lb between the distance La from P3(xₜ, yₜ) to P2(xₜ₋₁, yₜ₋₁) and the distance Lb from P2(xₜ₋₁, yₜ₋₁) to P1(xₜ₋₂, yₜ₋₂) shown in FIG. 7.

Concerning Angle Z3(t)

The angle Z3(t), which is one of the feature amounts corresponding to the newest coordinates (xₜ, yₜ) in the frame t, is calculated by the following equation.

Z3(t)=atan{(xₜ−xₜ₋₁)/(yₜ−yₜ₋₁} Angle:

This is developed as follows in a triangle, which is configured of a line segment La, a horizontal line Wa, and a vertical line Ha and includes P3(ₜ, yₜ) and P2(xₜ₋₁, yₜ₋₁) corresponding to apexes shown in FIG. 7.

Z3(t)=atan{(xₜ−xₜ₋₁)/(yₜ−yₜ₋₁)}=atan(Wa/Ha)

Accordingly, Z3(t)=atan{(xₜ−xₜ₋₁)/(yₜ−yₜ₋₁)} corresponds to an angle a at the apex P3(xₜ, yₜ) of the triangle which is configured of the line segment La, the horizontal line Wa, and the vertical line Ha and includes P3(xₜ, yₜ) and P2(xₜ₋₁, yₜ₋₁) as apexes shown in FIG. 7.

Concerning Angular Difference Z4(t)

The angular difference Z4(t), which is one of the feature amounts corresponding to the newest coordinate (xt, yt) in the frame t, is calculated by the following equation.

Z4(t)=atan{(xₜ−xₜ₋₁)/(yₜ−yₜ₋₁)}−atan{(xₜ₋₁−xₜ₋₂)/(yₜ₋₁−yₜ₋₂)} Angular difference:

This corresponds to a difference (α−β) between the angle α at the apex P3(xₜ, yₜ) of the triangle which is configured of the line segment La, the horizontal line Wa, and the vertical line Ha and includes P3(xₜ, yₜ) and P2(xₜ₋₁, yₜ₋₁) as the apexes shown in FIG. 7 and an angle β at the apex P2(xₜ₋₁, yₜ₋₁) of a triangle which is configured of a line segment Lb, a horizontal line Wb, and a vertical line Hb and includes P2(xₜ₋₁, yₜ₋₁) and P1(xₜ₋₂, yₜ₋₂) as apexes shown in FIG. 7.

These four feature amounts Z1 to Z4 for the newest coordinate point in each frame are sequentially acquired and stored on the memory. In a case where memory capacity is limited, it is also possible to employ a setting in which coordinate information corresponding to a prescribed number of frames, such as 100 frames in the past from the newest depiction position 81 shown in FIG. 6, for example, is stored on the memory and update memory data by deleting the coordinate information of the oldest frame in response to an input of coordinate information corresponding to the newest frame.

In a case where the memory capacity is sufficient, a configuration is also applicable in which track data corresponding to a past track of a pen is also stored on a non-volatile memory and is kept in the memory even after a power of the information processing apparatus is turned off and a predicted track is estimated by performing similarity determination and the like by using the accumulated past data when depiction is newly started after the power is turned on.

In addition, a configuration is also applicable in which the memory accumulated data is associated with a user identifier (user ID) and processing utilizing accumulated data corresponding to a user is performed in accordance with a user. The similar tracks are searched for by calculating the aforementioned feature amounts by using the coordinate information corresponding to the tracks in a plurality of frames, which is stored on the memory, and comparing the feature amounts.

In addition, the feature amounts of the last track and the feature amounts acquired from other past tracks are the target of comparison.

k past track regions with high similarity are selected by the comparison processing, where k is a predetermined number, and is three, for example, in the example of FIG. 6.

A similarity determination equation is as follows.

D(t, t′)=ΣᵢΣ⁴ⱼ₌₁wⱼ(Zⱼ(t−i)−Zⱼ(t′−i))²

The above equation is the similarity determination equation, and it is determined that a small feature amount distance D(t, t′) calculated by the above equation represents higher similarity.

In the above similarity determination equation, t′ corresponds to the number of frame in which a track of the coordinates (x_{t′}, y_{t′}) of the newest depiction position 81 shown in FIG. 6 is displayed as an updated track. That is, t′ is the number of frame in which depiction of the newest track immediately before the predicted track is executed. t corresponds to an arbitrary past frame in which coordinate (xₜ, yₜ) of an arbitrary position on the depicted track are displayed. i corresponds to a frame section as a target of the similarity comparison and corresponds to the number of frames which are necessary to depict a track of the last track 82 shown in FIG. 6, for example.

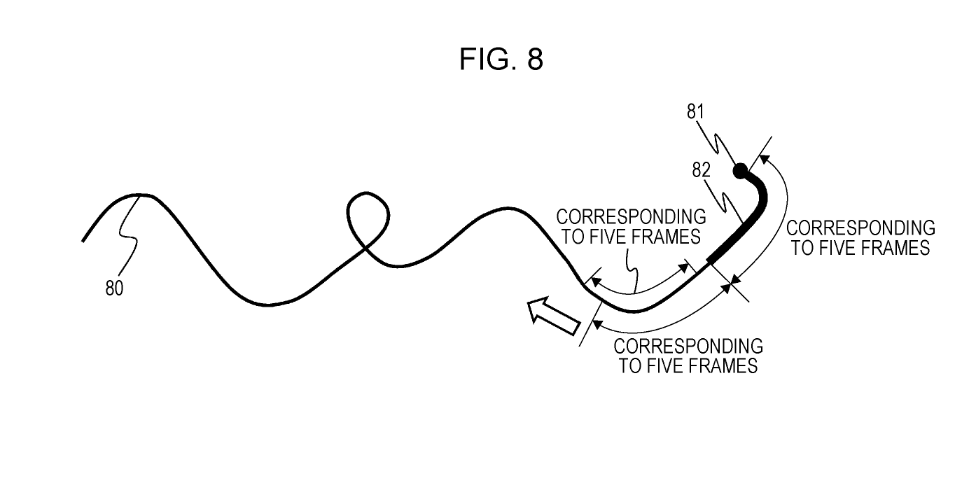

In a case where the last track 82 shown in FIG. 6 is a track generated by processing of displaying five frames, for example, comparison processing to which coordinate position information for the five frames is applied is executed. That is, in the case where the last track 82 is the track generated by the processing of displaying the five frames as shown in FIG. 8, track information of all the five frames selected from the depicted track 80 before the last track 82 is the similarity determination target with respect to the last track.

j is a coefficient in accordance with types of the feature amounts. That is, j corresponds to each of the coefficients 1 to 4 in Z1 to Z4.

wj represents a weight which is set for each of the feature amounts Zj=Z1 to Z4. Various values can be set as the weight in accordance with a situation. Specifically, a constant value may be set such that all the weights wj=1.

As an example of a weight setting in a case where the display device is a full HD, for example, a weight setting may be performed such that

the weight w1 corresponding to the speed Z1=1,

the weight w2 corresponding to the acceleration Z2=100,

the weight w3 corresponding to the angle Z3=10, and

the weight w4 corresponding to the angular difference Z4=1000.

The feature amount distances D(t, t′) are calculated, and a predetermined number of, namely k feature amount distances are selected in an order from the smaller feature amount distance. The selected k regions are regarded as similar tracks. As described above, the similar tracks R1 to R3 shown in FIG. 6, for example, are selected. In the example of FIG. 6, k=3.

In addition, a configuration is also applicable in which the weight wj set for each feature amount is set such that a larger weight is set for newer data, for example. That is, a configuration is also applicable in which feature amount distance data is calculated by setting a weight in accordance with a distance such that a track that is closer to the last track in terms of a distance is selected with a priority.

A calculation equation of the feature amount distance D(t, t′) in the case where the similarity calculation is performed by setting a larger weight for newer data is set as follows.

D(t, t′)=Σᵢpow(ε, i)Σ⁴ⱼ₋₁wⱼ(Zⱼ(t−i)−Zⱼ(t′−i))² where ε represents a preset weight attenuation rate (0.0<ε≦1.0), and pow(ε, i) represents a weight (a function which becomes 1.0 at a newer track position and outputs a smaller value at an older track position).

As described above, a setting of calculating a feature amount distance by setting a larger weight for a newer track is applicable.

3-2. Concerning Predicted Track Determination Processing

Next, a description will be given of processing of determining the predicted track by using the plurality of similar tracks selected by the aforementioned processing.

In Steps S102 to S104 described above with reference to the flow in FIG. 5, processing of connecting the plurality of similar tracks, which are selected in Step S101, to the leading end of the newest depiction position and determining the final predicted track by the average processing is performed.

The predicted track determination processing will be described. Coordinates (xᵤ, yᵤ) configuring the predicted track are calculated by the following equation (predicted track coordinate calculation equation).

xᵤ=(1/k)Σ^{k}ₙ₌₁xᵤ(n)′

yᵤ=(1/k)Σ^{k}ₙ₌₁yᵤ(n)′

In addition, u in the above predicted track coordinate calculation equation corresponds to a frame number. For example, when the frame number of the frame displayed at the newest depiction position 81 shown in FIG. 6 is t, u is a frame number after the frame number t and satisfies t<u.

The frame u corresponds to a future frame, for which track depiction has not yet been completed.

Other parameters are set as follows.

k is the number of extracted similar tracks.

n is a variable from 1 to k.

xᵤ(n)′ is an x coordinate in the frame u of the predicted line corresponding to each of the similarity tracks where n=1 to k.

yᵤ(n)′ is a y coordinate in the frame u of the predicted line corresponding to each of the similarity tracks where n=1 to k.

A description will be given of calculating the x coordinate: xᵤ(n)′ and the y coordinate yᵤ(n)′ in the frame u of the predicted line corresponding to each of the similar tracks where n=1 to k, which are used in the above predicted track coordinate calculation equation.

First, a speed vₜ(n), an angle aₜ(n), and coordinates (xₜ(n)′, yₜ(n)′) at the leading end position (newest position) of each of the k similar tracks extracted in the aforementioned processing (Step S101 in the flow shown in FIG. 5) are calculated as follows.

vₜ(n)=sqrt{(xₜ−xₜ₋₁)²+(yₜ−yₜ₋₁)²} (1) newest speed:

aₜ(n)=atan{(xₜ−xₜ₋₁)/(yₜ−yₜ₋₁)} (2) newest angle:

xₜ(n)′=xₜ, yₜ(n)′=yₜ (3) newest coordinates:

where n is a variable corresponding to the number (k) of the extracted similar tracks and satisfies n=1 to k.

Next, a speed vᵤ(n) and an angle aᵤ(n) in the future frame (frame u) which is predicted in accordance with the n-th (n=1 to k) similar track are calculated by the following calculation equations.

Vᵤ(n)=Vᵤ₋₁(n)Z₂(sn+u−t)

aᵤ(n)=aᵤ₋₁(n)Z₄(sn+u−t)

where sn is a frame number of each of the k similar tracks where n=1 to k.

Furthermore, xy coordinates (xᵤ(n)′, yᵤ(n)′) in the future frame (frame u) which is predicted in accordance with the n-th (n=1 to k) similar track by applying the above calculation equations are calculated by the following calculation equations.

xᵤ(n)′=xᵤ₋₁(n)′+Vᵤ(n)cos(aᵤ(n))

yᵤ(n)′=yᵤ₋₁(n)′+Vᵤ(n)cos(aᵤ(n))

The xy coordinates in the future frame u which corresponds to each of the k similar tracks are calculated in accordance with the above equation. The respective coordinates are xy coordinates which configure k auxiliary predicted tracks shown in FIG. 6.

The coordinates configuring the final predicted track are calculated by using the aforementioned predicted track coordinate calculation equation by applying the xy coordinates (xᵤ(n)′, yᵤ(n)′) for the frame u corresponding to the k similar tracks calculated by the aforementioned equation. That is, the coordinates (xᵤ, yᵤ) configuring the predicted track are calculated by the following equations (predicted track coordinate calculation equation) as described above.

xᵤ=(1/k)Σ^{k}ₙ₋₁xᵤ(n)′

yᵤ=(1/k)Σ^{k}ₙ₋₁yᵤ(n)′

The track calculated by the above equations is the finally determined predicted track (Qf) 86 shown in FIG. 6. In the above track calculation equation, the setting of calculating the final predicted track by simply averaging the coordinates configuring the predicted track, which are calculated based on all the similar tracks, is employed. However, a configuration is also applicable in which coordinates of the final predicted track are calculated by setting a larger weight for a similar track with higher similarity and executing arithmetic mean, for example.

A description will be given of the processing.

Parameters are set as follows.

sₙ: time (or frames) of k similar points

rₙ: a similarity order of k similar points (a point with the highest similarity=1, a point with the lowest similarity=k)

qₙ=pow(β, rₙ₋₁): a weight of the n-th similar point (the value becomes 1.0 at the point (rₙ=1) with the highest similarity, and the value becomes smaller as the value of rₙ becomes larger)

β: a preset weight attenuation rate (0.0<β≦1.0)

By using the above parameters, the coordinates (xᵤ, yᵤ) configuring the predicted track are calculated by the following equations (predicted track coordinate calculation equations).

xᵤ=(Σ^{k}ₙ₌₁qₙxᵤ(n)′)/(Σ^{k}ₙ₌₁qₙ)

yᵤ=(Σ^{k}ₙ₌₁qₙyᵤ(n)′)/(Σ^{k}ₙ₌₁qₙ)

The configuration as described above is applicable in which the coordinates of the predicted track are calculated by performing the weighting in accordance with similarity.

4. Concerning Example of Processing in Accordance with Reliability of Predicted Track

If the prediction processing based on so-called mechanical learning, such as the aforementioned kNN method, is executed, prediction accuracy is degraded when “a track with a relatively low frequency” is depicted.

Examples of the “track with a relatively low frequency” include “rapid change in direction (which often occurs in writing Chinese characters), “stopping”, and “continuous curves”.

That is, prediction accuracy by the learning processing is enhanced for tracks which often appear while prediction accuracy is degraded for tracks which appear with a low frequency. To describe in an extreme manner, prediction accuracy for depiction other than a straight line or a relatively smooth curve is degraded. This tendency significantly appears when a progress of the learning is not enough. If the prediction accuracy is degraded, the predicted track is depicted at a position which is different from a position of the input device such as a dedicated pen at a high rate.

Such erroneous depiction of the predicted track inconveniences the user in some cases.

Accordingly, it is preferable not to reflect the prediction result to the depiction in a case where the prediction accuracy is determined to be low.

Hereinafter, a description will be given of an example of the processing.

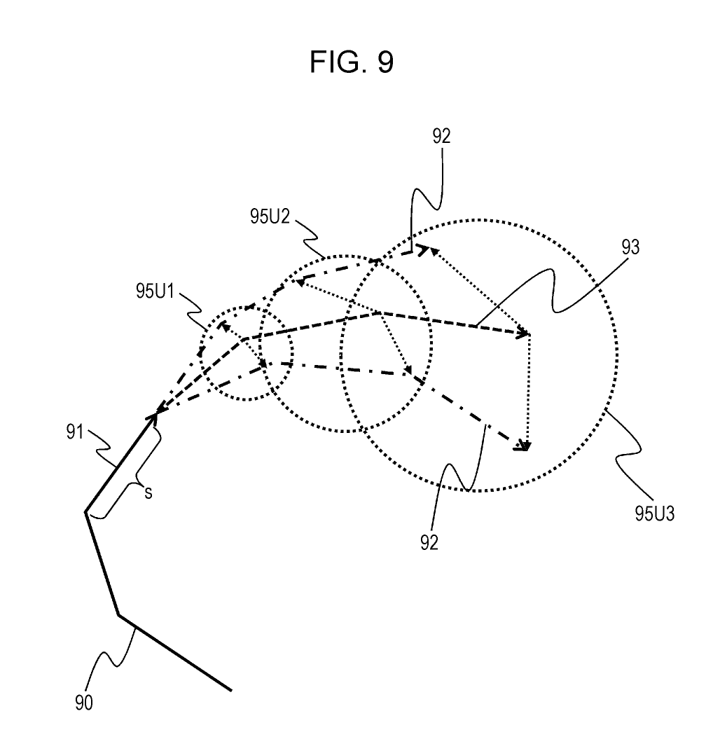

First, a description will be given of reliability of the predicted track with reference to FIG. 9.

FIG. 9 shows a depicted track 90 and the last track 91 which corresponds to the leading end of the depicted track 90. The predicted track is set after the last track 91.

Based on the aforementioned kNN method, k auxiliary predicted tracks 92 are calculated at an arbitrary timing. Since the k predicted tracks respectively represents k similar tracks in the past, the positions of the k tracks are converged in a case of a simple track such as a track of a straight line, and in contrast, the positions of the k tracks are distributed in a case where a rapid change occurs in the track, for example.

The state where the plurality of auxiliary predicted tracks 92 “are distributed” means that likeliness of an optimal track which is similar to the track acquired this time from among the past tracks is low. That is, a probability in that an average value of k auxiliary predicted tracks is similar to the correct answer is low. Thus, a standard deviation σ of the respective coordinate positions of the k auxiliary predicted tracks is calculated, and processing is performed in accordance with how large the calculated standard deviation σ is.

Specifically, an average of the k auxiliary predicted tracks is calculated, the coordinate positions of the finally determined predicted track are determined, and the finally determined predicted position is depicted, only when the calculated standard deviation is small. With such a configuration, it is possible to reduce prediction errors which are recognized by the user.

Circles (standard deviations 95U1 to 95U3 of the auxiliary predicted tracks) shown in FIG. 9 are circles which conceptually represent how large the standard deviations of the coordinate points of the plurality of (k) auxiliary predicted tracks in the future frames U=t+1, t+2, and t+3 after the displayed frame t of the last track 91.

A larger circle represents a larger standard deviation, that is, a larger circle represents that the auxiliary predicted tracks are significantly distributed and likeliness of the finally determined predicted track to be calculated as an average value is low.

The final position of the last track 91 corresponds to the coordinate position of the track displayed in the frame t, and the small circle 95U1 shown thereafter represents a standard deviation of the plurality of predicted coordinates calculated from the plurality of auxiliary predicted tracks in the future frame U=t+1.

The next circle 95U2 represents a standard deviation of the plurality of predicted coordinates calculated from the plurality of auxiliary predicted tracks in the future frame U=t+2.

The next circle 95U3 represents a standard deviation of the plurality of predicted coordinates calculated from the plurality of auxiliary predicted tracks in the future frame U=t+3.

An average of the k auxiliary predicted tracks is calculated, the coordinate positions of the finally determined predicted track is determined, and the finally determined predicted track is depicted only when the standard deviation is small, that is, only when the prediction results are not significantly distributed. With such a configuration, it is possible to reduce prediction errors which are recognized by the user.

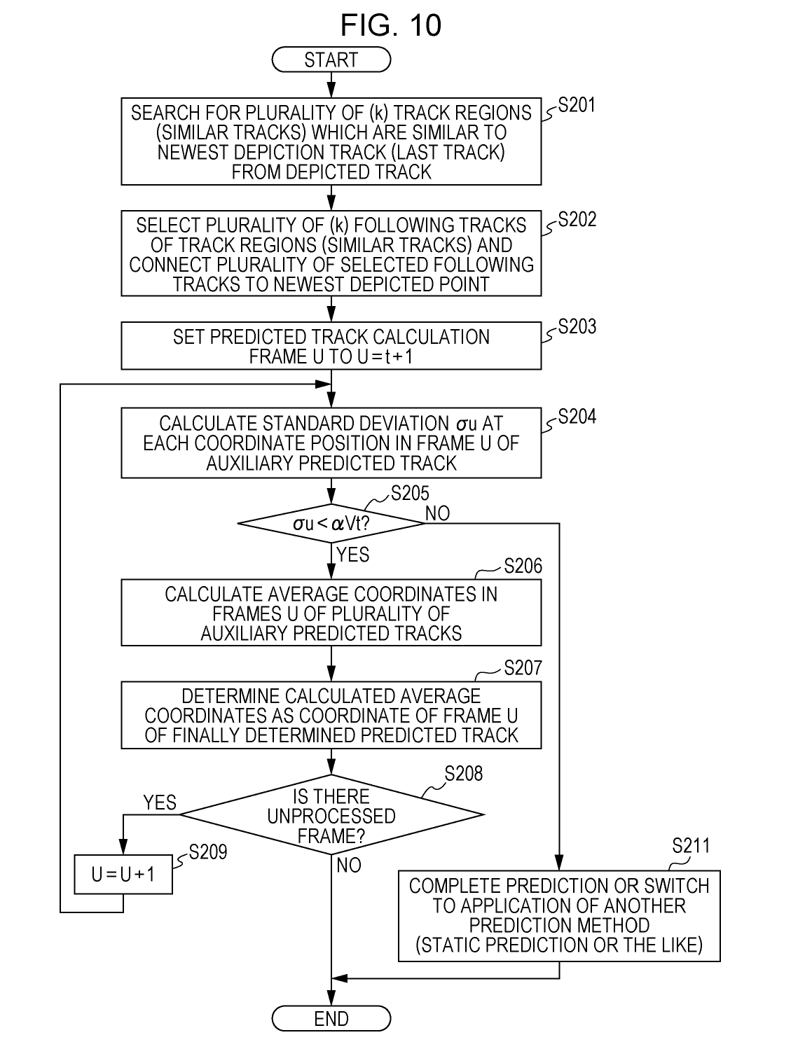

A description will be given of sequences of the standard deviation calculation processing and predicted track calculation and depiction processing which is changed in accordance with a processing result, with reference to the flowchart in FIG. 10.

FIG. 10 is a flowchart illustrating a sequence of the predicted track estimation and depiction processing to which the kNN method is applied in the same manner as in the aforementioned flow in FIG. 5.

In addition, the processing shown in the flowchart is executed under control of the data processing unit in the information processing apparatus according to the present disclosure, specifically, the data processing unit which is configured of a CPU or the like provided with a program executing function, for example. The program is stored on the memory, for example, in the information processing apparatus.

Step S201

Steps S201 and S202 are the same processing as that in the processing in Steps S101 and S102 in the aforementioned flow shown in FIG. 5.

First, in Step S201, a plurality of (k) track regions (similar tracks) which are similar to the newest depicted track (last track) are searched for from the depicted track. The depicted track corresponds to a track region, for which the input device track analysis has been completed and the line depiction processing in accordance with the track, namely the processing of outputting the line to the display unit and displaying the line on the display unit has been completed.

The newest depicted track (last track) corresponds to the newest track region of the depicted track, which is a track region in contact with the depiction delay part. Specifically, the last track corresponds to a depicted region with a predetermined length, which includes the newest depiction position 72 shown in FIG. 4, for example. In Step S201, the plurality of (k) track regions (similar tracks) which are similar to the newest depicted track (last track) are searched for from the depicted track. k is a prescribed number such as 3, 5, 10, 20, or 30.

Step S202

Next, in Step S202, the following tracks of the plurality of (k) track regions (similar tracks) searched for in Step S201 are estimated or selected, and the plurality of following tracks are connected after the newest depiction position. The newest depiction position corresponds to the newest depiction position 72 shown in the example of FIG. 4.

Step S203

In Step S203 and the following steps, processing in consideration with the standard deviations of the predicted tracks is performed.

Standard deviations of the plurality of predicted tracks corresponding to the plurality of similar tracks, namely the k auxiliary predicted tracks shown in FIG. 9 are calculated in units of future frames, and processing is performed in units of frames in accordance with the calculation results.

First, in Step S203, the first future frame U is set to satisfy U=t+1.

t is a frame number of the frame in which the newest depiction position of the leading end of the last track is displayed. U=t+1 corresponds to the next frame of the frame t in which the newest depiction position is displayed.

Step S204

In Step S204, standard deviations σu of the coordinate positions in the frames U of the k auxiliary predicted tracks are calculated. In addition, the coordinate positions corresponding to the k auxiliary predicted tracks are acquired by the same processing as that described above with reference to the flow in FIG. 5. In Step S204, the standard deviations σu of the k coordinate positions corresponding to the k frames U are further calculated.

Step S205

Next, in Step S205, processing of determining whether or not depiction of a predicted track is reasonable, namely whether or not it is possible to depict a predicted track with reliability, based on the standard deviations σu corresponding to the frames U. The reliability determination is executed by applying the following determination equation.

σu<αVt Determination Equation:

In the equation, αVt corresponds to a depiction determination threshold value. In addition, α represents a preset coefficient, and Vt represents a depiction speed of the last track.

Vt corresponds to a length s of the last track in FIG. 9. s corresponds to a distance by which the track advances in one frame from the frame t−1 to the frame t.

Vt represents the length by which the track advances in the last one frame and corresponds to a speed of the last track 81.

The coefficient α is a parameter which can be changed in accordance with a situation, and for example, the coefficient α is set to be small in a case of a setting according to which depiction is allowed only when the reliability is high, and is set to be large in a case where depiction is also allowed even when the reliability is low. For example, the coefficient α may be a value which can be set by the user.

If the above determination equation is satisfied, that is, if the standard deviation σu is less than the threshold value, it is determined that a predicted track with relatively high reliability can be determined, and the processing proceeds to Step S206. In contrast, if the above determination equation is not satisfied, that is, the standard deviation σu is equal to or greater than the threshold value, it is determined to be difficult to depict a predicted track with high reliability, and the processing proceeds to Step S211.

Step S206

In Step S206, average coordinates of the k coordinates corresponding to the frames U of the plurality of (k) auxiliary predicted tracks are calculated.

Step S207

In Step S207, the average coordinates calculated in Step S206 are determined as coordinates of the finally determined predicted track corresponding to the frame U, and processing of depicting the predicted track is executed.

Step S208

In Step S208, it is determined whether or not there is an unprocessed frame on which the depiction processing after the frame U is to be executed.

If there is an unprocessed frame to be processed, the processing proceeds to Step S209. If there is no unprocessed frame to be processed, the processing is completed.

Step S209

In Step S209, processing of updating the frame number U is executed. That is, the updating is performed so as to satisfy U=U+1.

The frame number in the above setting is updated, and the processing on the next frame is started in Step S204 and the following steps.

If the processing on all the unprocessed frames is completed, the processing is completed.

Step S211

Step S211 is processing which is executed in a case where a result of the determination processing in Step S205 is NO. That is, Step S211 is executed when it is determined in Step S205 that the standard deviation σu is equal to or greater than the threshold value and it is difficult to depict a predicted track with high reliability.

In such a case, it is determined in Step S211 to complete the prediction processing. Alternatively, prediction method changing processing of switching the processing to static prediction processing in the related art is executed.

By executing the processing in accordance with the flow shown in FIG. 10 as described above, it is possible to depict only a predicted track with high reliability and to suppress display of an erroneously predicted track, which is caused by depicting a predicted track with low reliability.

5. Concerning Processing to Which Input Device Pressure Detection Information is Applied

In a case of using a dedicated pen as the input device, for example, it is possible to detect pressure of the pen onto the display unit, to calculate reliability in accordance with the pressure, and to control depiction of a predicted track in accordance with the calculated reliability.

In addition, the value of pressure of the input device onto the display unit is detected by a pressure detection sensor which is set in the input device or on the surface of the display unit, and the detected value is input to the control unit and is used for the reliability calculation.

In the case of using a dedicated pen as the input device, the value of pressure gradually decreases from several frames before a frame, in which the pen loses contact with (is released from) the surface of the display unit, when the pen is separate from the screen, as a feature of an input by the pen. Particularly, when a character is depicted and a part corresponding to “sweep” of the character is depicted, for example, the tendency in that the value of pressure gradually decreases significantly appears.

In the aforementioned embodiment, the following feature amounts are used as the feature amounts which are used for the similar track determination processing:

(1) the speed: Z1;

(2) the acceleration: Z2;

(3) the angle: Z3; and

(4) the angular difference: Z4.

In addition to these feature amounts, a value of pressure: Z5 corresponding to a pen pressure of the input device onto the display unit and an amount of variations in the value of pressure: Z6 are further added.

Specifically, the feature amounts Z5 and Z6 are defined as follows, where pₜ represents the value of pressure in the frame t (or at the time t).

Z5(t)=pₜ the value of pressure in the frame t:

Z6(t)=pₜ−pₜ₋₁ the amount of variations in the value of pressure in the frame t:

These feature amounts Z5 and Z6 are additionally used to determine the similar tracks.

In a case of predicting a pen pressure of the predicted track after the similarity determination, it is possible to calculate a predicted pen pressure (a value of pressure) pᵤ in the future frame u (or at future time t) of the predicted track by the following equation:

pᵤ=(1/k)Σ^{k}ₙ₌₁pₛₙ₊ᵤ₋ₜ. the predicted pen pressure:

Here, u represents a frame number (or time), and k represents the number of extracted similar tracks.

n represents a variable from 1 to k.

sn represents a frame number (or time) of each of the k similar tracks, where n=1 to k.

By introducing the value of pressure corresponding to the pen pressure as a feature amount for the learning processing, prediction accuracy when the pen is released, for example, is enhanced.

6. Concerning Modification Example of Predicted Track Calculation and Depiction Processing

Next, some modification examples will be described below in which it is possible to expect to further enhance the effects by implementing the aforementioned embodiment as basic processing.

6-1. Processing of Changing Learning Pattern in Accordance with Type of Depicted Object

For example, a learning pattern is changed in accordance with a type of a depicted object which is input by the user. Specifically, the learning pattern is changed in accordance with which of a drawing and a character the object depicted by the user is, and in the case of a character, the learning pattern is changed in accordance with a type of the character, such as an alphabet, a Japanese character, a Chinese character, or hiragana.

The prediction processing is executed by applying a fact that features of shapes differ depending on depicted objects such as a drawing and a text. For example, Chinese characters include more straight lines, lines folding at sharp angles, and short lines than alphabet letters and have features which are significantly different from those of the alphabet letters which include a lot of long curves as a whole. By changing the feature amounts to be used for extracting similar tracks and determining a predicted track in accordance with the type of the depicted object as described above, it is possible to more accurately perform the processing.

6-2. Processing of Changing Predicted Track Depiction State Depending on Relative Positions of Visual Line and Pen Tip

A description will be given of an example of processing of changing a predicted track depiction state depending on relative positions of a visual line and a pen tip when the predicted track is depicted on the display unit.

In a case of depicting a line by using a dedicated pen as the input device, for example, a space on the left side of a right hand can be easily observed when a right-handed user holds the pen with the right hand and depicts the line from the left side to the right side. However, when the user depicts a line from the right to the left, the space on the right side is hidden from the view by the hand.

If the predicted track is depicted at a part which is hidden from the view, it is difficult for the user to observe the predicted track. Accordingly, the prediction processing for such a part is not executed. Alternatively, a countermeasure of reducing the number of prediction frames is employed.

That is, control is performed so as to increase the number of prediction frames in the case of depicting a line segment from the left side to the right side and to stop the prediction or reduce the number of prediction frames in the case of depicting a line segment from the right side to the left side.

In addition, processing which is opposite to that for the right-handed user is performed for a left-handed user.

6-3. Concerning Examples of Processing Combined with Other Prediction Processing

By combining the aforementioned track prediction processing with other prediction processing, it is possible to further enhance the prediction accuracy.

(a) Combination with Word Prediction Processing

In a case where the object depicted by the user is a document, it is possible to enhance the prediction accuracy by performing word prediction and using a result of the word prediction.

For example, processing of estimating a next character to be written by the word prediction, estimating a track in accordance with the estimated character, and increasing a weight for an auxiliary predicted track which is similar to the estimation result is performed.

(b) Processing of Switching and Using Dynamic Prediction and Static Prediction

Although the aforementioned processing to which the learning processing is applied, in which similar tracks are searched for from the past track and a predicted track is determined, is dynamic prediction processing, the static prediction processing in the related art in which track estimation processing based on linear approximation or the like by utilizing only data of the last track is also effective in some cases.

In a case where learning in a specific environment is not sufficient, for example, when an image depicting application is activated or when a user is changed, precision is degraded in the case of the dynamic prediction method. At this time, the prediction processing which employs the static prediction method is effective in some cases. If a depicted track which is sufficient to search for similar tracks is acquired thereafter, the static prediction is switched to the dynamic prediction.

By switching the dynamic prediction and the static prediction in accordance with a situation as described above, it is possible to perform optimal prediction in accordance with the situation.

(c) Combination with Prediction in Consideration of Character Database

In general, a character data base (font database) is stored on a memory in a device by which characters can be input. Such a device has a function of performing processing of searching for characters, which are similar to a track depicted by a user, from the character database in many cases.

By using the function, processing of selecting a character, which is similar to a character written by the user, from the database, estimating a track in accordance with the selected character, and increasing a weight for an auxiliary predicted track which is similar to the estimation result is performed.

(d) Example of Prediction Processing Which Does Not Depend on Character Scale

For example, when the user depicts a character, the size (scale) thereof differs according to time and circumstances. In the aforementioned embodiments, it is difficult to precisely perform similarity determination in some cases if scales differ in determining the similarity tracks.

In order to solve the problem, processing of determining a character size of a character depicted by the user and converting the determined character size into an absolute scale for a preset standard size is executed, and comparison processing using tracks with the absolute scale is then executed.

In addition, the scale conversion processing is executed by combining enlargement processing, size reduction processing, interpolation processing, thinning processing, and the like.

By performing such processing, it is possible to reduce erroneous determination based on a difference in scales.

6-4. Other Modification Examples

In relation to up to which position the predicted track is to be depicted, various settings can be made. For example, a setting according to which the maximum processing in accordance with processing ability of the information processing apparatus is performed, a setting according to which the predicted track is depicted at a position before a prescribed actual pen position by a predetermined distance, or a configuration in which user can set a desired range may be employed.

In addition, a configuration is also applicable in which the processing ability (performance) of the information processing apparatus is benchmarked and calculated and a predicted track depiction range is set in accordance with the calculation result.

In addition, a device type of the information processing terminal is determined, and the predicted track depiction range may be determined. Alternatively, a configuration is also applicable in which the predicted track depiction range is determined in accordance with an executed application depending on which of application for depicting characters and application for executing picture drawing the executed application is, for example.

Furthermore, in the case of performing the similarity determination processing and the like by using the past depicted track, a configuration is also applicable in which past similar tracks are associated and stored with a user ID as an identifier of the user who depicts the track on the memory, and when similarity determination or predicted track depiction is performed, the past track information of the same user is selected and utilized.

In addition, a configuration is also applicable in which whether the user is a right-handed user or a left-handed user is determined or input when the device is used and the predicted track depiction setting is changed in accordance with the hand dominance information. As a method of determining a delay time and determining the number of prediction frames by the hardware configuration, it is possible to apply the following processing, for example.

First, information such as a product number of the information processing apparatus terminal, an ID of a touch panel used in the terminal, an ID of a touch panel driver, an ID of a graphic chip, and the like is acquired. Then, a delay time is estimated with reference to a database in which correspondence data between these IDs and delay times is stored, and the number of prediction frames is determined.

In addition, the data base to be referred to at this time may be stored on the information processing terminal or may be provided in a server on a network. In the case of using the server, the acquired ID information is transmitted from the terminal to the server, and estimated delay time or the number of prediction frames is received from the server.

Alternatively, a configuration is also applicable in which a delay time is actually measured and the number of prediction frames is determined. That is, a configuration is applicable in which time until depiction is completed after an input by the input device is detected is measured inside and the number of prediction frames is determined based on the measured time. In addition, the detection of the input by the input device and the detection of the completion of the depiction may be estimated based on a signal from the touch detection driver or the graphic driver, or may be estimated by image recognition based on an image captured by a camera.

In addition, a configuration is also applicable in which whether or not to execute the track prediction processing can be switched in accordance with an input device. For example, a setting may be made such that the track prediction is executed in a case where the input device is a dedicated pen, and the track prediction is not executed in a case where the input device is a finger (touch input).

Other examples of the input device include a mouse, and the configuration is applicable in which whether or not to execute the track prediction can be switched in accordance with various input devices.

In addition, a configuration is also applicable in which whether to execute the track prediction processing is set in response to a user setting.

Furthermore, a configuration is also applicable in which control is performed such that a difference between a predicted track and an actual track is sequentially calculated and the track prediction is stopped (turned off) when the difference is equal to or greater than a prescribed threshold value.

In a case of executing the track prediction and completing the image depicting application, a learning result data which is applied to the track prediction is stored as log data associated with an ID of the user who uses the application on the memory. By performing such processing, it is possible to use the learning data corresponding to the user, which is stored on the memory, when the application is started again by inputting the user ID and to immediately execute the track prediction using the learning result corresponding to the user.

7. Concerning Example in Which Predicted Track Depiction State is Controlled

Next, a description will be given of an example in which a predicted track depiction state is controlled.

In the processing according to the present disclosure, the processing of predicting a future track by learning the depicted track (actual track) and depicting the predicted track is executed.

However, there is also a case where the predicted track displayed on the display unit deviates from the actual track. If the “predicted track” with a possibility of deviating from the actual track is displayed in the same manner as the “depicted track” corresponding to the actual track, there is a case where the display inconveniences the user.

Hereinafter, a description will be given of an embodiment in which the “predicted track” with a possibility in that the predicted track is an erroneously predicted track is displayed in a different manner from the “depicted track” corresponding to the actual track.

In relation to predicted track display control processing methods, the following five processing examples will be described in order.

### PROCESSING EXAMPLE 1

The “depicted track” corresponding to the actual track is displayed as a solid line, and the “predicted track” is displayed by changing at least one of a color, transparency, and a thickness so as to appear less outstandingly than the solid line.

### PROCESSING EXAMPLE 2

The predicted track is updated for each frame. That is, a displayed predicted track is deleted in the next depiction frame, and a new predicted track is depicted therein.

### PROCESSING EXAMPLE 3

At least one of a length, a color, transparency, and a thickness is changed in accordance with a reliability index value of the predicted track.

### PROCESSING EXAMPLE 4

Switching between ON and OFF, namely between display and non-display of the depiction of the predicted track is performed in accordance with a situation.

### PROCESSING EXAMPLE 5

In the case where the predicted track deviates from the actual track, control is performed so as to display the predicted track less outstandingly by changing the display state of the predicted track.

In addition, the predicted track determination processing is the same as the aforementioned processing. In the example of the display control processing described below, processing of controlling the display state of the predicted track which is determined by the aforementioned processing of estimating the predicted track is performed.

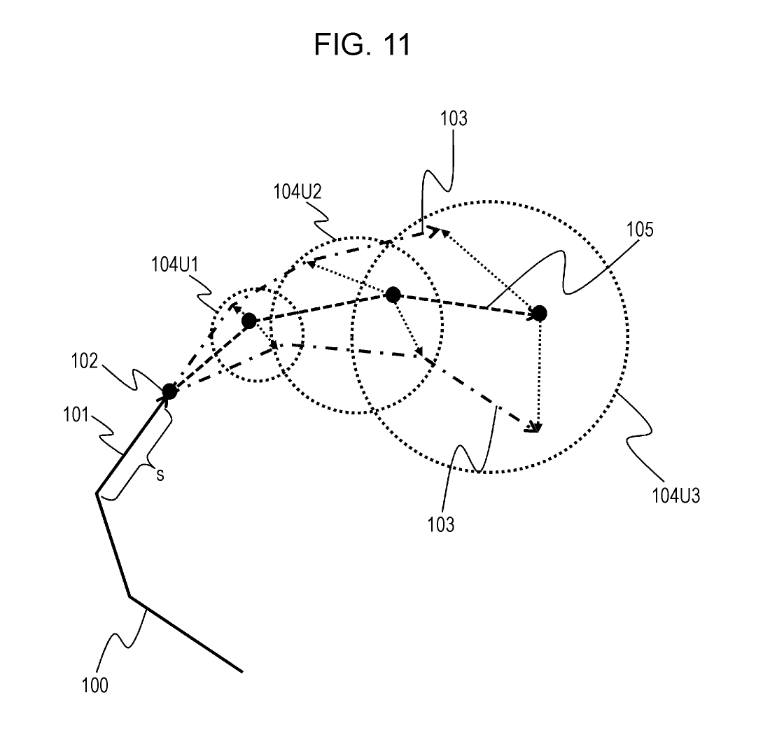

FIG. 11 is a diagram showing examples of a plurality of (k) auxiliary predicted tracks and standard deviations at the respective coordinate positions of the auxiliary predicted tracks, which are applied to the predicted track determination processing, in the same manner as FIG. 9 described above.

FIG. 11 shows a depicted track 100 which is displayed in accordance with an actual track of a dedicated pen as the input device, auxiliary predicted tracks 103 which are calculated by the processing according to the aforementioned embodiment, that is, the processing in accordance with the flow shown in FIG. 5, for example, and a predicted track 105 which is calculated as an average track of the auxiliary predicted tracks 103.

The leading end of the depicted track 100 is at the newest depiction position 102 whose coordinates are (x, y), and the newest depiction position 102 is the newest depiction position 102 displayed in the frame t.

The depicted track from the frame t−1 to the frame t corresponds to the last track with a length s. k auxiliary predicted tracks 103 are calculated at an arbitrary timing based on the k NN method as described above. How the k predicted tracks are distributed differs in accordance with a situation. The state where the plurality of auxiliary predicted tracks 103 are distributed means that likeliness of an optimal track which is similar to the track acquired this time from among the past tracks is low. That is, a probability in that a predicted track 105 set by averaging the k auxiliary predicted tracks is equal to the actual track is low.

As an index indicating a degree of distribution, standard deviations σ at the respective coordinate positions of the k auxiliary predicted tracks are calculated. Circles (standard deviations 104-U1 to U3 of the auxiliary predicted tracks) shown in FIG. 11 are circles which conceptually represent how large the standard deviations of the coordinate points of the plurality of (k) auxiliary predicted tracks in the future frames U=t+1, t+2, and t+3 after the displayed frame t of the last track 101.

A larger circle represents a larger standard deviation, that is, a larger circle represents that the auxiliary tracks are significantly distributed and likeliness of the finally determined predicted track to be calculated as an average value is low.

The final position of the last track 101 corresponds to the coordinate position of the track displayed in the frame t, and the small circle 104-U1 shown thereafter represents a standard deviation of the plurality of predicted coordinates calculated from the plurality of auxiliary predicted tracks in the future frame U=t+1.

The next circle 104-U2 represents a standard deviation of the plurality of predicted coordinates calculated from the plurality of auxiliary predicted tracks in the future frame U=t+2.

The next circle 104-U3 represents a standard deviation of the plurality of predicted coordinates calculated from the plurality of auxiliary predicted tracks in the future frame U=t+3. According to the embodiment, the standard deviations are used as reliability index values corresponding to the predicted tracks, and display control is executed in accordance with the reliability index values, for example.

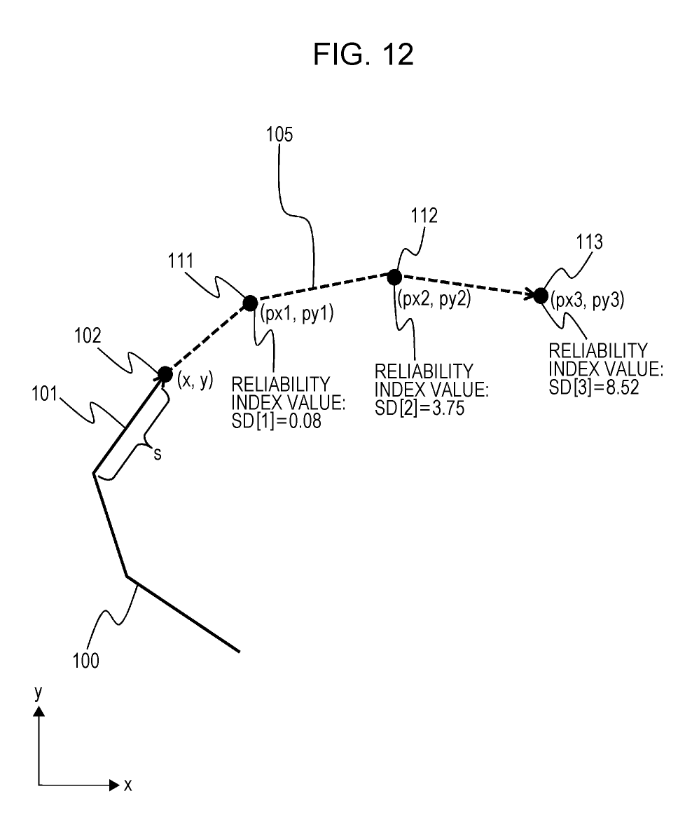

FIG. 12 is a diagram showing an example in which reliability in the respective future frames U=t+1, t+2, and t+3 is calculated.

As shown in FIG. 12, the predicted track 105 calculated by the aforementioned processing in accordance with the flow shown in FIG. 5 is depicted after the newest depiction position (x, y) 102 displayed in the frame t. The newest depiction position 102 is the newest depiction position 102 displayed in the frame t. The depicted track from the frames t−1 to t corresponds to the last track with the length s.

The predicted track 105 calculated by the aforementioned processing in accordance with the flow shown in FIG. 5 is depicted after the newest depiction position (x, y) 102 displayed in the frame t.

The predicted track is set by connecting the following respective points:

a prediction point 111 of predicted coordinates (px1, py1) in the future frame u=t+1;

a prediction point 112 of predicted coordinates (px2, py2) in the future frame u=t+2; and

a prediction point 113 of predicted coordinates (px3, py3) in the future frame u=t+3.

The predicted track 105 is set and displayed by connecting the above respective points.

As described above with reference to FIGS. 5 and 6, the predicted track 105 is a track which is calculated as an average track of the auxiliary predicted tracks calculated in accordance with the plurality of similar tracks.

That is, a plurality of (k) similar tracks which are similar to a region including the last track up to the newest depiction position 102 are extracted from the depicted track 100, and an average value of the k auxiliary predicted tracks which are set based on the similar tracks is set as the predicted track 105, as described above with reference to FIG. 6.

As described above with reference to FIG. 11, the k extracted predicted tracks include predetermined distribution. The degree of distribution of the k auxiliary predicted tracks is calculated as the standard deviation σ and is used as the reliability index value.

For example, a reliability index value (=standard deviation) at each point of the predicted track 105 after the newest depiction position (x, y) displayed in the frame t is set as shown in FIG. 12.

Standard deviations, namely reliability index values calculated based on coordinate positions corresponding to the k auxiliary predicted tracks are set as follows:

a reliability index value at a prediction point 111 of predicted coordinates (px1, py1) in the future frame u=t+1: SD[1]=0.08;

a reliability index value at a prediction point 112 of predicted coordinates (px2, py2) in the future frame u=t+2: SD[2]=3.75; and

a reliability index value at a prediction point 113 of predicted coordinates (px3, py3) in the future frame u=t+3: SD[3]=8.52.

The reliability index values corresponding to the respective frames are calculated as described above.

In addition, the reliability index values are values which correspond to the standard deviations indicating degrees of distribution of the auxiliary predicted track as described above, represent that the reliability is higher when the reliability index values are smaller, and represent that the reliability is lower when the reliability index values are larger. In accordance with these reliability index values SD[u] of the predicted track, which correspond to the respective future frames u, the display state of the predicted track is controlled.

Although the following description will be given on the assumption that u represents a frame number, it is also possible to perform processing in which u represents time. Specifically, the display control in accordance with the reliability index values can be executed as one of the aforementioned five processing states, namely as one of the following five processing examples or as a combination thereof.

### PROCESSING EXAMPLE 1

The “depicted track” corresponding to the actual track is displayed as a solid line, and the “predicted track” is displayed by changing at least one of a color, transparency, and a thickness so as to appear less outstandingly than the solid line.

### PROCESSING EXAMPLE 2

The predicted track is updated for each frame. That is, a displayed predicted track is deleted in the next depiction frame, and a new predicted track is depicted therein.

### PROCESSING EXAMPLE 3

At least one of a length, a color, transparency, and a thickness is changed in accordance with a reliability index value of the predicted track.

### PROCESSING EXAMPLE 4

Switching between ON and OFF, namely between display and non-display of the depiction of the predicted track is performed in accordance with a situation.

### PROCESSING EXAMPLE 5

In the case where the predicted track deviates from the actual track, control is performed so as to display the predicted track less outstandingly by changing the display state of the predicted track.

Hereinafter, a description will be given of specific states and effects of the respective processing examples.

### PROCESSING EXAMPLE 1

In the processing example 1, the “depicted track” corresponding to the actual track is displayed as a solid line, and the “predicted track” is displayed by changing at least one of a color, transparency, and a thickness so as to appear less outstandingly than the solid line.

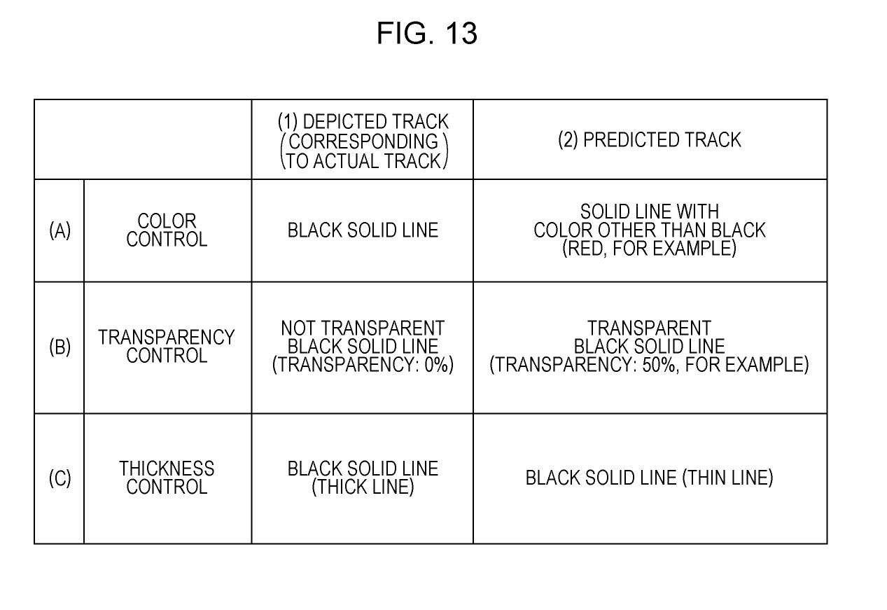

A specific example of the display control will be described with reference to FIG. 13.

FIG. 13 shows examples of display states of the following respective tracks:

(1) the depicted track (corresponding to the actual track); and

(2) the predicted track.

The following display control is performed for the two tracks:

(A) a display color is controlled such that (1) the depicted track (corresponding to the actual track) is displayed as a black solid line and (2) the predicted track is displayed as a solid line with a color (red, for example) other than black;

(B) transparency of the displayed line is controlled such that (1) the depicted line (corresponding to the actual line) is displayed as a non-transparent black solid line (transparency: 0%) and (2) the predicted track is displayed as a transparent black solid line (transparency: 50%, for example); and

(C) a thickness of the displayed line is controlled such that (1) the depicted track (corresponding to the actual track) is displayed as a black solid line (thick line) and (2) the predicted track is displayed as a black solid line (thin line).

For example, one of (A) to (C) or a combination thereof is performed as the display control.

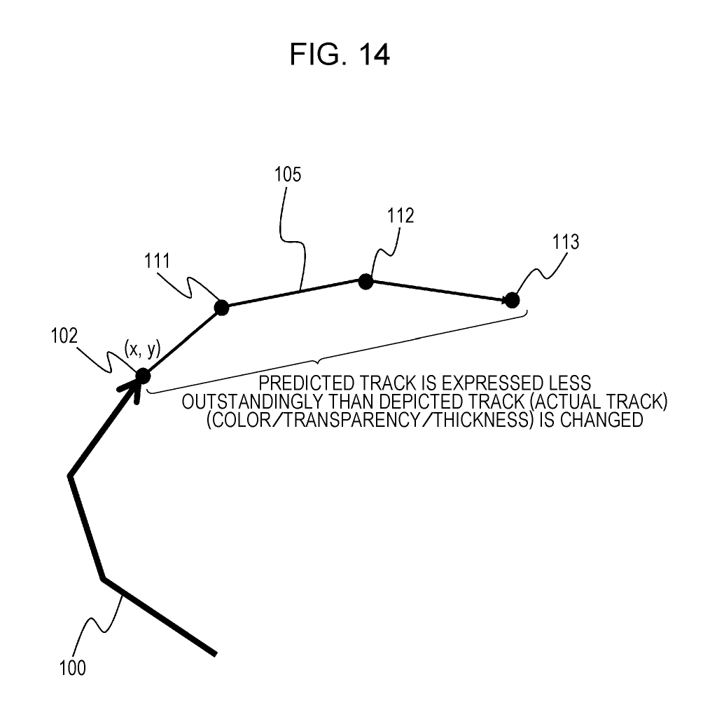

A specific display example will be shown in FIG. 14. The example shown in FIG. 14 is an example corresponding to the example of the display control in (C) in FIG. 13. That is, FIG. 14 shows an example in which the thickness of the displayed line is controlled, (1) the depicted track (corresponding to the actual track) is displayed as a black solid line (thick line), and (2) the predicted track is displayed as a black solid line (thin line) in the control example.

By performing the display control for displaying (1) the depicted track (corresponding to the actual track) and (2) the predicted track in different states as described above, the user (the person who depicts the image) can clearly distinguish and recognize the depicted track corresponding to the actual track and the predicted track, and the depiction processing which is not adversely affected by the predicted track can be performed.

Furthermore, the display state of the predicted track may be set in accordance with reliability by developing the display control in the processing example 1.

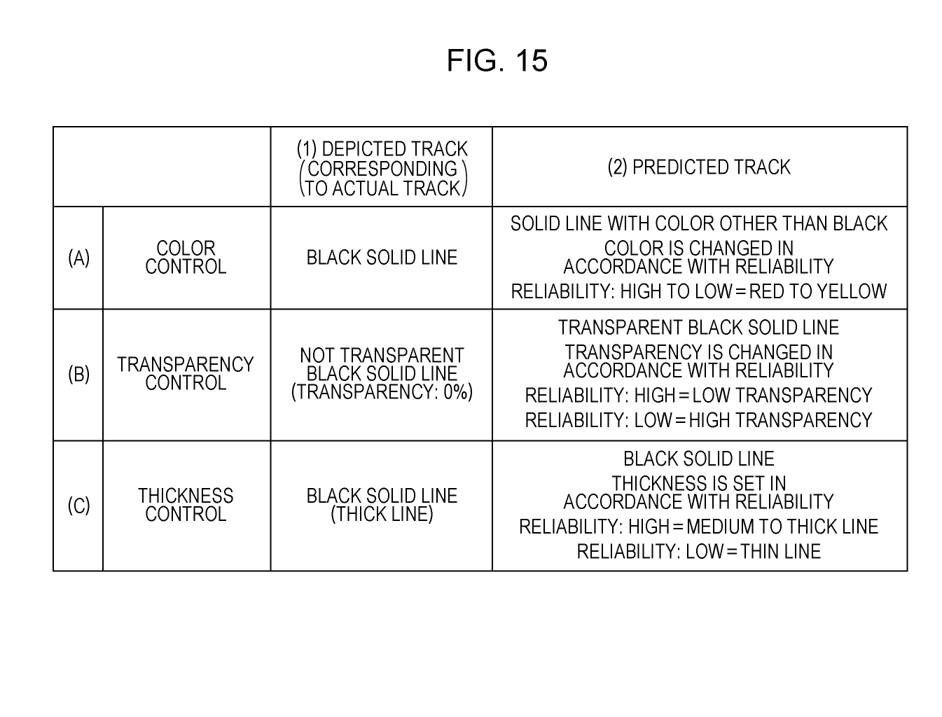

A specific example of display control will be described with reference to FIG. 15.

FIG. 15 shows examples of display states of the following respective tracks in the same manner as in FIG. 13:

(1) the depicted track (corresponding to the actual line); and

(2) the predicted track.

The following display control is performed for these two tracks.

(A) The display color is controlled such that (1) the depicted track (corresponding to the actual track) is displayed as a black solid line and (2) the predicted track is displayed as a solid line with a color other than black.

Furthermore, the color of the predicted track is changed in accordance with reliability.

For example, a setting is employed in which the color is changed in accordance with the reliability, and for example, a predicted track with high reliability is displayed with a red color, and a predicted with low reliability is displayed with a yellow.

(B) The transparency of the displayed line is controlled such that (1) the depicted track (corresponding to the actual track) is displayed as a non-transparent black solid line (transparency: 0%) and (2) the predicted track is displayed as a transparent black solid line.

Furthermore, the transparency of the predicted track is changed in accordance with reliability.

For example, transparency of a predicted track with high reliability is set to be low, and transparency of a predicted track with low reliability is set to be higher.

(C) The thickness of the displayed line is controlled such that (1) the depicted track (corresponding to the actual track) is displayed as a black solid line (thick line) and (2) the predicted track is displayed as a black solid line which is thinner than the depicted track.

Furthermore, the thickness of the predicted track is changed in accordance with reliability.

For example, a setting is employed in which the thickness of the line is changed in accordance with the reliability, and for example, a predicted track with high reliability is represented as an intermediate thick line, and a predicted track with low reliability is represented as a thin line.

For example, one of (A) to (C) or a combination thereof is performed as the display control.

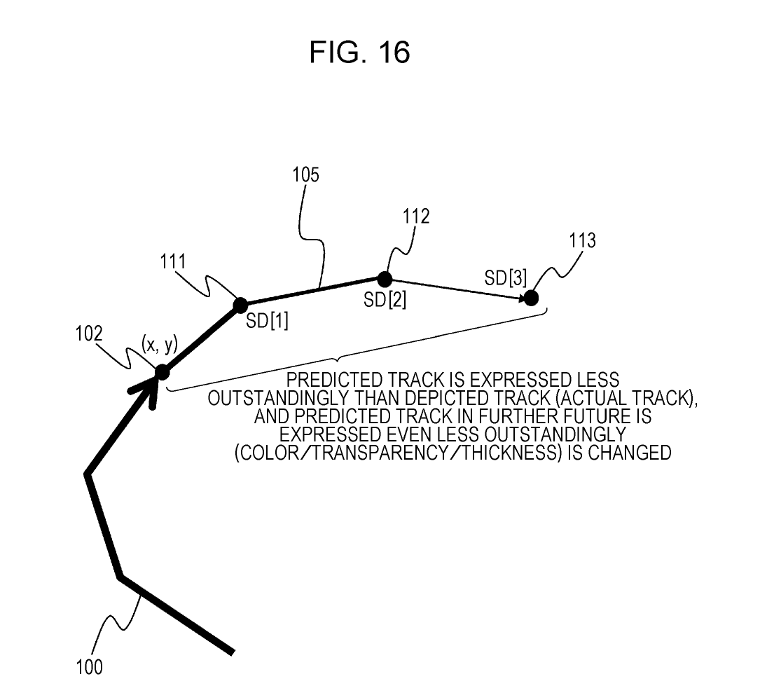

A specific display example will be shown in FIG. 16. FIG. 16 shows an example corresponding to the example of display control shown in (C) in FIG. 15. That is, FIG. 16 shows an example in which the thickness of the displayed line is controlled, (1) the depicted track (corresponding to the actual track) is displayed as a black solid line (thick line), (2) the predicted track is displayed as a black solid line, a predicted track with high reliability is displayed as an intermediate thick line, and a predicted track with low reliability is displayed as a thin line, in the control example.

By performing the display control such that (1) the depicted track (corresponding to the actual track) and (2) the predicted track are displayed in different states and the predicted track is displayed in a different manner in accordance with reliability as described above, the user (the person who depicts the image) can clearly distinguish the depicted track corresponding to the actual track from the predicted track and further check the reliability of the predicted track.

### PROCESSING EXAMPLE 2

Next, a description will be given of the processing example 2. In the processing example 2, the predicted track is updated for each frame. That is, a displayed predicted track is deleted in the next depiction frame, and a new predicted track is depicted therein in the processing example.

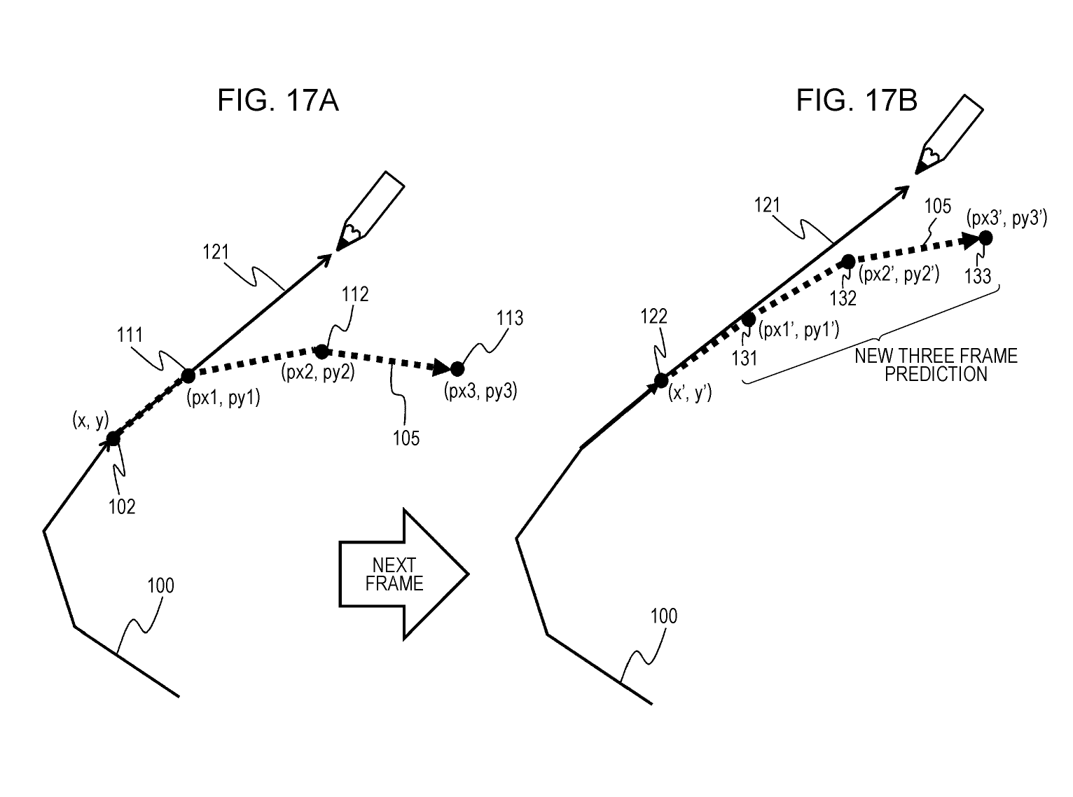

A description will be given of a specific display example with reference to FIGS. 17A and 17B.

FIGS. 17A and 17B show examples in which the following two continuous frames are displayed:

FIG. 17A: a display example of a frame n; and

FIG. 17B: a display example of a frame n+1.

In the display example of the frame n shown in FIG. 17A, a predicted track 105, which connects 111: a prediction point 1, 112: a prediction point 2, and 113: a prediction point 3, after the newest depiction position 102 of the depicted track 100 corresponding to the actual track. In addition, it is assumed that the actual track at this timing is the actual track 121 shown in the drawing. The actual track 121 is not displayed.

In the display example of the frame n+1, which is the next frame, in FIG. 17B, the newest depiction position is updated to the updated newest depiction position 122. The position substantially coincides with 111: the prediction point 1 in the frame n. Furthermore, the respective prediction points of the predicted track 105 are also updated, the respective prediction points are set as 131 to 133: updated prediction points 1 to 3 at positions after the frame n, and the predicted track 105 is displayed so as to connect these updated prediction points.

In the processing example 2, the predicted line is deleted for each frame, and new points are depicted again as described above. With such a configuration, the predicted line with a length in accordance with a refresh rate of the screen is updated, and display in which the predicted line is replaced with a predicted line with high likeliness is realized for each frame.

### PROCESSING EXAMPLE 3

Next, a description will be given of the processing example 3. In the processing example 3, at least one of a length, a color, transparency, and a thickness is changed in accordance with a reliability index value of the predicted track. The processing example 3 is achieved by extending the processing example 1, and the display control is performed such that the length of display is changed in accordance with a reliability index value of the predicted track.

The reliability index value is a value corresponding to a standard deviation of the auxiliary predicted track described above with reference to FIGS. 11 and 12, represents that the reliability of the predicted track is higher when the reliability index value is smaller, and represents that the reliability of the predicted track is lower when the reliability index value is lager.

In a case where the reliability index value is large, there is a high possibility in that the predicted track deviates from the actual track. In such a case, the predicted track is not displayed according to this setting.

Specifically, a reliability index value (standard deviation) of each prediction point described above with reference to FIGS. 11 and 12 is compared with a preset threshold value (reliability threshold value), and if the reliability index value is not less than the predetermined threshold value, a countermeasure of not depicting the predicted track immediately before the prediction point is employed,

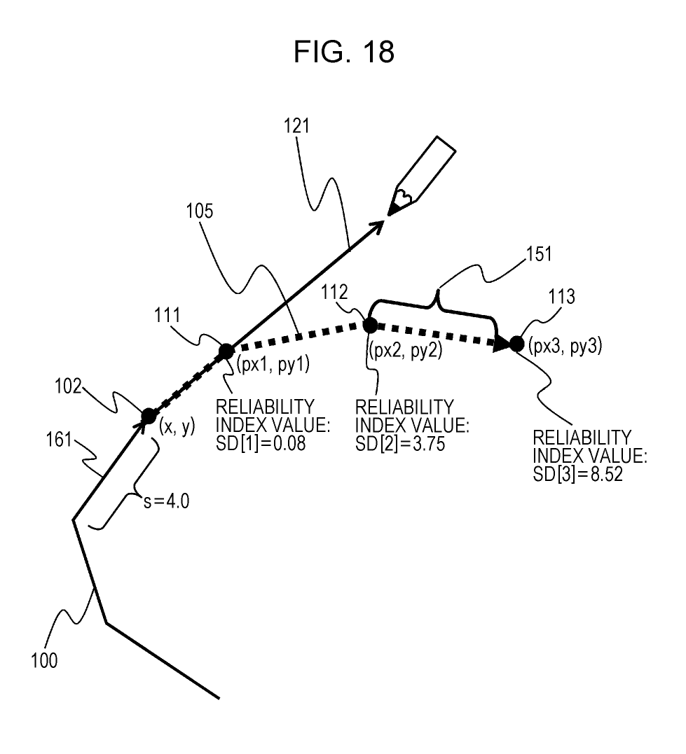

A description will be given of the example of the display control processing with reference to FIG. 18. In FIG. 18, it is assumed that reliability index values of the three prediction points which configure the predicted track 105 to be displayed are calculated as follows:

(a) the reliability SD[1] of 111: the prediction point 1=0.08;

(b) the reliability SD[2] of 112: the prediction point 2=3.75; and

(c) the reliability SD[3] of 113: the prediction point 3=8.52.

In addition, the above reliability index values correspond to the standard deviations σ of the coordinate positions of the auxiliary predicted tracks corresponding to the similar tracks which are used for calculating the respective prediction points as described above with reference to FIGS. 11 and 12, and represent that the reliability is higher when the reliability index values are smaller.

Here, the threshold value which determines display and non-display of the predicted line is value which varies in accordance with a speed of the last track of the depicted track, namely in accordance with a moving speed of the last track 161 shown in FIG. 18. Specifically, a value acquired by multiplying a prescribed constant α by a moving speed Vt of the last track 161, namely α×Vt is used as a threshold value.

α is a preset coefficient.

As Vt, it is possible to apply the moving distance s of the last track in one frame. That is, the moving speed may be defined as a moving distance in one frame, the track moving distance s between frames shown in FIG. 18 may be applied, and α×s may be used as a threshold value.

For example, the threshold value α×s is compared with the reliability index value (standard deviation) SD[u] of a prediction point on the predicted track. In addition, u means the future frame number after the displayed frame t at the newest depiction position. As for u in FIG. 18, t of the displayed frame t at the newest depiction position is assumed to satisfy t=0 and reliability index values of prediction points corresponding to the future frames 1, 2, and 3 are shown as SD[1], SD[2], and SD[3], respectively.

A comparison determination equation between the reliability index value of each prediction point and the threshold value α×s, namely a determination equation SD[u]<α×s is used to determine whether or not to display the predicted track after each prediction point.

When the above determination equation is satisfied, that is, when the reliability index value SD[u] of each prediction point is smaller than the threshold value α×s, it is determined that the reliability of the prediction point is high, and the predicted track up to the prediction point is depicted and displayed.

In contrast, when the reliability index value SD[u] of each prediction point is a value which is not less than the threshold value α×s, it is determined that the reliability of the prediction point is low, and the depiction and display of the predicted track up to the prediction point is stopped. For example, the predicted track depiction determination using the reliability index value of each prediction point as shown in FIG. 18 is set as follows.

In an example, a setting is employed in which the coefficient α=1.5 and the moving distance s in a frame of the last track=4.0. In the case of such a setting, the reliability index value of each prediction point is substituted into the comparison determination equation between the reliability index value SD[u] of each prediction point shown in FIG. 18 and the threshold value SD[u]<α×s, and it is determined whether or not the above equation is satisfied.

The reliability index value of the prediction point 1 satisfies SD[1]=0.08.

That is, SD[1]=0.08 and α×s=1.5×4.0=6, and therefore, the equation SD[1]=0.08<6.0 is satisfied, and the determination equation SD[u]<α×s is satisfied.

In addition, the reliability value of the prediction point 2 satisfies SD[2]=3.75.

That is, SD[2]=3.75 and α×s=1.5×4.0=6, and therefore, the equation SD[2]=3.75<6.0 is satisfied, and the determination equation SD[u]<α×s is satisfied.

In addition, the reliability value of the prediction point 3 satisfies SD[3]=8.52.

That is, SD[3]=8.52 and α×s=1.5×4.0=6, and therefore, the equation SD[3]=8.52<6.0 is not satisfied.

That is, the determination equation SD[u]<α×s is not satisfied.

As described above, the reliability index values SD[1] and SD[2] of the prediction point 1 and the prediction point 2 are smaller than the threshold value αs=1.5×4.0=6.0, and the determination equation SD[u]<α×s is satisfied. Therefore, it is determined that the reliability is high, and depiction and display of the predicted tracks up to the respective points are executed.

However, the reliability index value SD[3] of the prediction point 3 is not smaller than the threshold value αs=1.5×4.0=6.0, and the determination equation SD[u]<α×s is not satisfied. Therefore, it is determined that the reliability is low and that depiction and display of the predicted track immediately before the prediction point are not executed.

As shown in FIG. 18, the predicted track from 112: the prediction point 2 to 113: the prediction point 3 corresponds to a non-displayed predicted track 151.

Since the predicted track with low reliability is not displayed and only the predicted tracks with high reliability are displayed in the processing example 3, the user (the person who depicts the image) can perform processing by observing only the predicted tracks which are closer to the actual track.

In the above description of the processing example 3, the coefficient α in the determination example SD[u]<α×s is a fixed value such as 1.5. In the processing example described above, depiction and display of the predicted track up to each point is executed when the determination equation is satisfied and it is determined that the reliability is high, and depiction and display of the predicted track up to each track is stopped when the determination equation is not satisfied and it is determined that the reliability is low.

That is, the above processing example is for the display control depending on reliability. In other processing examples, processing of displaying a predicted track, which is closer to the leading end of the predicted track, with a thinner color (with a higher degree of transparency) regardless of the reliability, processing of displaying the predicted track while gradually reducing color thickness, or a configuration in which the predicted track is displayed while the thickness of the line is further reduced is also applicable. In addition, the control may be implemented by performing processing of making a determination while changing the coefficient α in the above determination equation toward the leading end of the predicted track.

### PROCESSING EXAMPLE 4

Next, a description will be given of the processing example 4. The processing example 4 is a processing example in which switching between ON and OFF, namely between display and non-display of the depiction of the predicted track is performed in accordance with a situation.

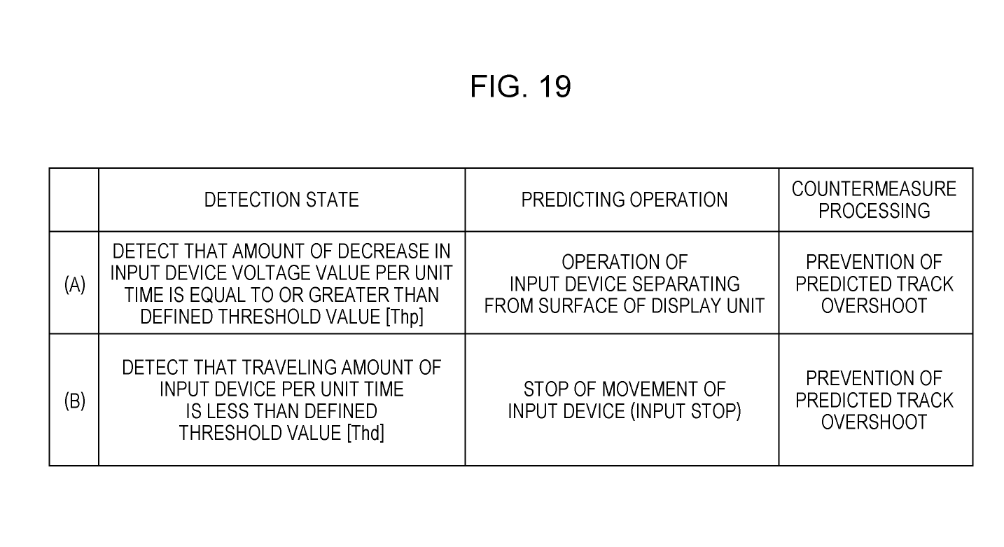

A description will be given of specific examples with reference to FIG. 19 and the following drawings.

FIG. 19 shows two detection states as conditions under which the processing example 4 is executed. In a case where any of the states (A) and (B) in FIG. 19 is detected, for example, the ON/OFF control of the predicted track is executed in accordance with the processing example 4. That is, the ON/OFF control in accordance with the processing example 4 is executed in the case of detecting the following situation:

(A) a case where it is detected that an amount of decrease in a value of pressure of an input device per a unit time is equal to or greater than a prescribed threshold value [Thp]; or

(B) a case where it is detected that a moving amount of the input device per a unit time is less than a prescribed threshold value [Thd].

When the state (A) or (B) is detected, for example, the processing of turning off the depiction and the display of the predicted track is performed.

In the case of (A), it is expected that the input device such as a dedicated pen performs an operation of being separate from the display unit. If the predicted track is continuously displayed in such a state, there is a possibility in that overshoot, in which only the predicted track is depicted regardless of a fact that there is no actual track depicted by the user, occurs. In order to prevent such overshoot, the depiction of the predicted track is stopped in such a case.

In the case of (B), it is expected that movement of the input device such as a dedicated pen is stopped. If the predicted track is continuously displayed in such a state, there is a possibility in that overshoot, in which only the predicted track is depicted regardless of the fact that there is no actual track depicted by the user, occurs in the same manner as in the case of (A). In order to prevent such overshoot, the depiction of the predicted track is stopped in such a case.

In addition, the input device is not limited to a dedicated pen, and may be a finger in some cases.

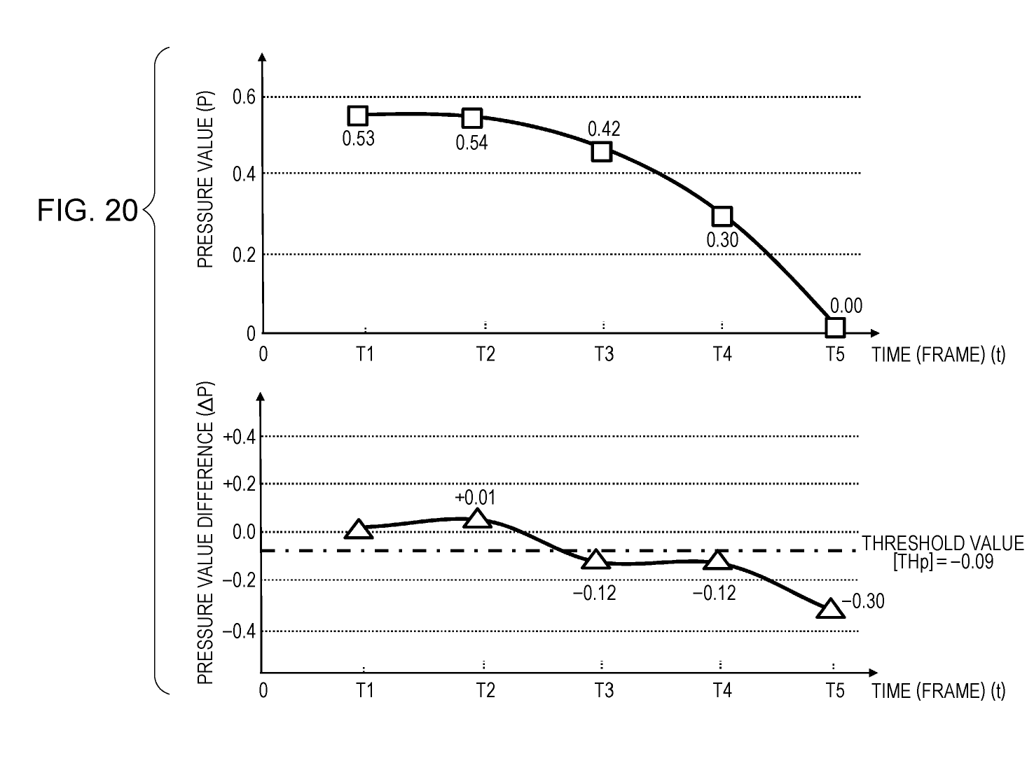

A description will be given of a variation in a specific value of pressure corresponding to (A) in FIG. 19, with reference to FIG. 20. The upper graph in FIG. 20 is a graph which represents temporal transition of the value of pressure (P) of the input device with respect to the display unit.

The horizontal axis represents time (t), and the vertical axis represents the value of pressure (P) of the input device with respect to the display unit. In addition, the time (t) represented by the horizontal axis may be replaced with a frame number of a displayed frame.

Transition of the value of pressure (P) from time T1 to time T5 is as follows:

time T1: the value of pressure=0.53;

time T2: the value of pressure=0.54;

time T3: the value of pressure=0.42;

time T4: the value of pressure=0.30; and

time T5: the value of pressure=0.00.

As described above, the value of pressure gradually decreases over time. This state is estimated to be a state in which the pen is gradually separate from the display unit, for example.

The lower graph in FIG. 20 is a graph which is created based on pressure value temporal transition data shown by the upper graph, and shows temporal transition of pressure value difference data indicating an amount of variation in the value of pressure per a unit time.

The horizontal axis represents time (t), and the vertical axis represents a difference in the values of pressure (ΔP) which is a value of a difference in the values of pressure of the input device with respect to the display unit per a unit time.

For example, a value of a difference in the values of pressure at the time T2=+0.01 represents a difference between the value of pressure at the time T2=0.54 and the value of pressure at the time T1, which is the previous pressure measurement time, =0.53, that is, a value of difference 0.54−0.53=+0.01.

A value of a difference at the time T3 is a difference between the value of pressure at the time T3 and the value of pressure at the time T2, and the same is true to the following difference values.

Transition of the difference in the values of pressure (ΔP) from the time T1 to the time T5 is as follows:

time T1: the difference in values of pressure=0.0;

time T2: the difference in values of pressure=+0.01;

time T3: the difference in values of pressure=−0.12;

time T4: the difference in values of pressure=−0.12; and

time T5: the difference in values of pressure=−0.30.

Here, it is assumed that the threshold value [THp] of the difference in the values of pressure is −0.09.

That is, the threshold value is set so as to satisfy THp=−0.09.

The display of the predicted track is controlled to be stopped (turned off) when the measured difference in the values of pressure indicates a larger amount of decrease than the threshold value (−0.09), at the respective time.

Since the difference in the values of pressure at the timing corresponding to the time T3=−0.12 indicates a larger amount of decrease than the threshold value (−0.09), the display of the predicted track is stopped at this timing in the example shown in FIG. 20. By performing such predicted track display stop processing, it is possible to prevent the overshoot, in which the predicted track is erroneously displayed after the input device of the user is separate from the display unit.

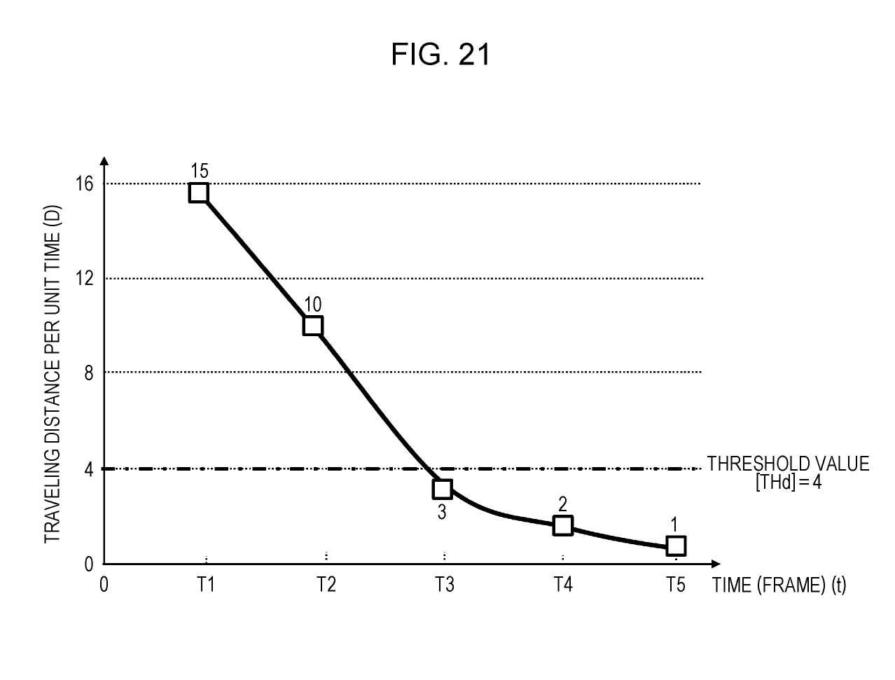

Next, a description will be given of processing in accordance with a moving amount of the input device per a unit time shown in (B) in FIG. 19, with reference to FIG. 21.

The graph shown in FIG. 21 is a graph which represents temporal transition of a moving distance (D) of the input device on the display unit per a unit time.

The horizontal axis represents time (t), and the vertical axis represents the moving distance (D) of the input device per a display unit time. In addition, the time (t) represented by the horizontal axis may be replaced with a frame number of a displayed frame.

The moving distance (D) per a unit time is a moving distance in one display frame, for example.

A moving distance=15 at the time T1 corresponds to a distance by which the input device moves from the time (T0) as a previous frame display timing to the time (T1) as the next frame display time.

Transition of the moving distance (D) per a unit time from the time T1 to the time T5 is as follows:

time T1: the moving distance per a unit time=15;

time T2: the moving distance per a unit time=10;

time T3: the moving distance per a unit time=3;

time T4: the moving distance per a unit time=2; and

time T5: the moving distance per a unit time=1.

As described above, the moving distance per a unit time gradually decreases with an elapse of time. This state is estimated to be a state in which the pen is gradually stopped on the display unit, for example.

Here, it is assumed that the threshold value [THd] of the moving distance per a unit time is 4.

That is, the threshold value is set so as to satisfy THd=4. The display of the predicted track is controlled to be stopped (turned off) when the measured moving distance per a unit time is less than the threshold value (4), at the respective time.

Since the moving distance per a unit time at the timing corresponding to the time T3 is 3 which is a value less than the threshold value (4), the display of the predicted track is stopped at this timing in the example shown in FIG. 21. By performing such predicted track display stop processing, it is possible to prevent the overshoot, in which the predicted track is erroneously displayed after the input device of the user is stopped on the display unit.

### PROCESSING EXAMPLE 5

Next, a description will be given of the processing example 5. The processing example 5 is a processing example in which a display state of the predicted track is changed so as to cause the predicted track to appear less outstandingly when the predicted track deviates from the actual track.

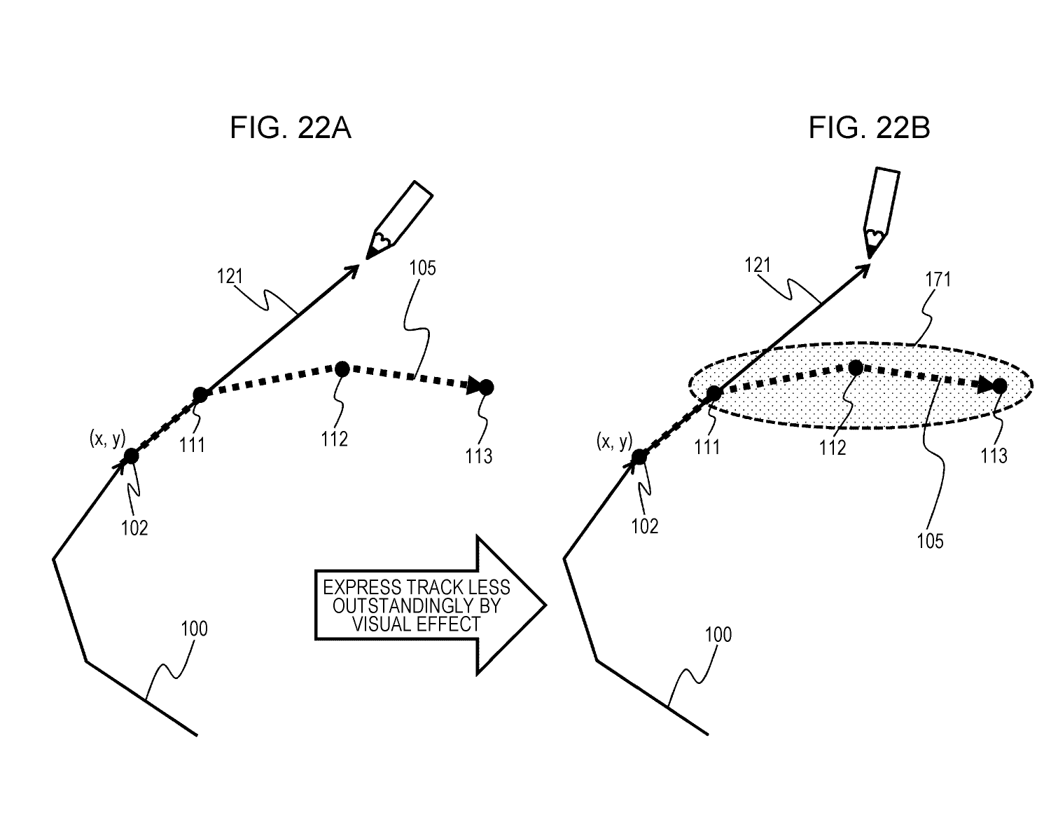

A description will be given of a specific example of the processing example 5 with reference to FIGS. 22A and 22B.

The display example shown in FIG. 22A is an ordinary display example. The depicted track 100 and the predicted track 105 are displayed. The predicted track 105 is displayed as a line connecting the prediction points 1 to 3. The prediction points 1 to 3 are at average positions of the coordinates configuring the plurality of auxiliary predicted tracks, which are calculated from the plurality of similar tracks, as described above. In addition, the actual track 121 shown in the drawing is not displayed on the display unit.

FIG. 22B shows a display example to which the processing example 5 is applied. In FIG. 22B, a display region of the predicted track 105 is set as a display state change region 171, and the display state of the predicted track 105 is changed such that the predicted track 105 appears less outstandingly. This is executed when the reliability of the predicted track is low.

Specifically, the aforementioned processing using reliability index value is performed, for example. The reliability index value SD[u] is calculated for each of 111 to 113: the prediction points 1 to 113: the prediction point 3 which are set as points configuring the predicted track 105. The reliability index value corresponds to a standard deviation (σ) of the coordinates configuring the plurality of auxiliary predicted tracks (see FIG. 11) which are applied to the prediction point calculation.

When the reliability index value is equal to or greater than the predetermined value and it is determined that the reliability is low, the display region of the predicted track 105 is set as the display state change region 171, and the display state of the predicted track 105 is changed such that the predicted track 105 appears less outstandingly as shown in FIG. 22B. By performing such display control, it is possible to present the erroneously predicted track, which is separate from the actual track, less outstandingly to the user (the person who depicts the image).

8. Concerning Sequence of Predicted Track Display Control Processing

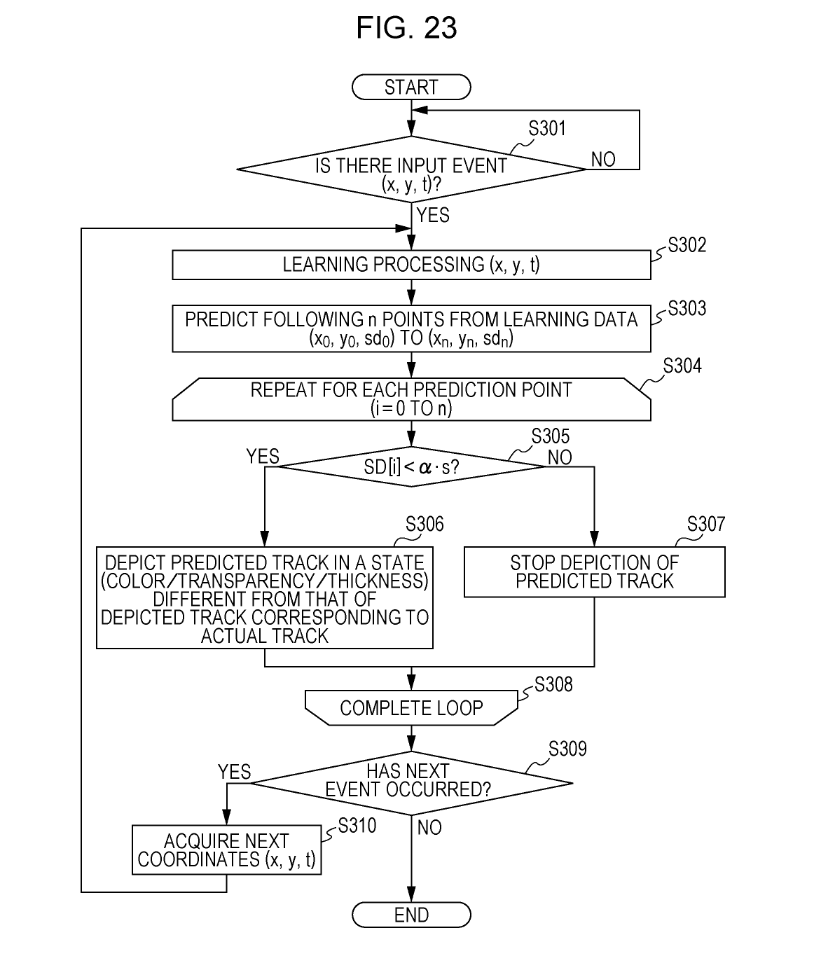

Next, a description will be given of a sequence of predicted track display control processing with reference to flowcharts in FIG. 23 and the following drawings.

The flowchart shown in FIG. 23 is a flowchart illustrating a basic sequence of the display control processing, which is executed for the display control in accordance with the aforementioned processing example 1 to the processing example 3.

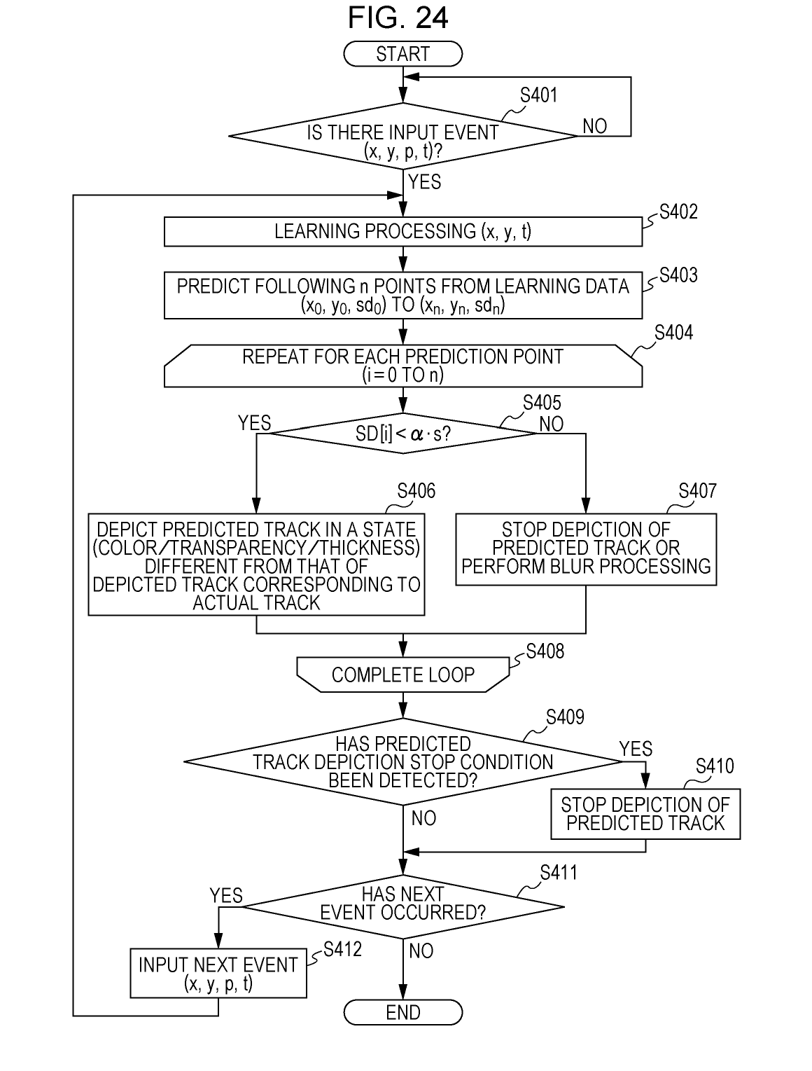

The flowchart in FIG. 24 is a flowchart illustrating a display control sequence for executing the predicted track depiction control in accordance with a value of pressure of the input device in addition to the aforementioned processing examples 1 to 3.

In addition, the processing shown in the flowcharts is executed by the data processing apparatus in the information processing apparatus according to the present disclosure, and is executed under control by the data processing unit configured of a CPU or the like with the program executing function, for example. The program is stored on a memory, for example, in the information processing apparatus.

First, a description will be given of a sequence for executing the display control in accordance with the aforementioned processing example 1 to the processing example 3 with reference to the flowchart in FIG. 23.

Step S301

First, in Step S301, an input event based on the input device is detected. Specifically, a processing of detecting a touch position of the dedicated pen, for example, with respect to the input display unit is performed. The processing is performed as processing of detecting time (or a frame)=t and information on coordinates (x, y) of a pen contact position corresponding to the time.

Step S302

The information processing apparatus depicts a track to be displayed on the display unit by applying the event information input in Step S301. However, the aforementioned region where the depiction processing does not catch up to the actual track of the pen, namely the depiction delay region 23 described above with reference to FIG. 1 is generated. In order to depict the predicted track in the depiction delay region, the learning processing using the past depicted track information is performed.

That is, the learning processing for estimating the predicted track is performed in accordance with the processing described above with reference to FIGS. 5 to 8, for example. Specifically, the processing of detecting the similar tracks, which are similar to the last track 82 including the newest depiction position 81 of the depicted track 80, from the depicted track 80, for example, is executed as shown in FIG. 6. In Step S302, the learning processing including the similar track detection is executed.

Step S303

In Step S303, the predicted track estimation processing by using the similar regions which are detected in Step S302 is executed. As a procedure of the predicted track estimation processing, processing of calculating k coordinates corresponding to the future frame u, which are estimated in accordance with the plurality of (k) similar tracks, and acquiring an average position of the k coordinates as coordinates configuring the predicted track in the frame u is performed.

If it is assumed that future frames up to the n-th point are prediction targets, coordinates which configure the predicted tracks and the reliability index values SD for the respective predicted coordinates are individually calculated. That is, (x₀, y₀, sd₀) to (xₙ, yₙ, sdₙ) are calculated. Here, a setting is employed in which a variable corresponding to the predicted future frame number is i and n+1 coordinate positions and the reliability index values are calculated for i=0 to n.

Step S304

Steps S304 to S308 correspond to loop processing of repeating the processing in accordance with the reliability index values of the respective coordinate positions for i=0 to n corresponding to the coordinates which configure the predicted track. In addition, the reliability index values SD are values corresponding to standard deviations σ of the plurality of estimated coordinate in the respective future frames, which are calculated based on the plurality of similar tracks, as described above with reference to FIG. 12 and the like.

Step S305

In Step S305, a reliability index value SD[i] of coordinates (xᵢ, yᵢ) which configure the predicted track is compared with the threshold value (α×s). As described above with reference to FIG. 18 and the like, α is a preset coefficient, and s represents a track moving distance s in a frame of the last track 161 as shown in FIG. 18.

In Step S305, it is determined whether or not the determination equation SD[i]<α×s is satisfied.

If the above determination equation is satisfied, the coordinates (xᵢ, yᵢ) which configure the predicted track mean that a standard deviation σ of the plurality of predicted coordinate positions calculated in accordance with the plurality of similar tracks as calculation sources is small, that is, the coordinates (xᵢ, yᵢ) mean that distribution of the plurality of predicted coordinate positions is small. In such a case, it is determined that the reliability of the coordinates (xᵢ, yᵢ) which configure the predicted track is high, and the processing proceeds to Step S306.

In contrast, if the above determination equation is not satisfied, the coordinates (xᵢ, yᵢ) which configure the predicted track mean that the standard deviation σ of the plurality of predicted coordinate positions calculated in accordance with the plurality of similar tracks as calculation sources is large, that is the coordinates (xᵢ, yᵢ) mean that the distribution of the plurality of predicted coordinate positions is large. In such a case, it is determined that the reliability of the coordinates (xᵢ, yᵢ) which configure the predicted track is low, and the processing proceeds to Step S307.

Step S306

If it is determined in Step S305 that the reliability of the coordinates (xᵢ, yᵢ) which configure the predicted track is high, the predicted track depiction processing is executed in Step S306. Here, the predicted track is depicted in a different manner from that of the depicted track corresponding to the actual track. That is, the predicted track is depicted and displayed in a state where at least one of the color, the transparency, and the thickness is set differently from that of the depicted actual track as described above with reference to FIGS. 13 and 14.

In addition, a configuration is also applicable in which at least one of the color, the transparency, and the thickness is further changed and displayed in accordance with the reliability as described above with reference to FIGS. 15 and 16. Moreover, the predicted track is sequentially updated and displayed every time a new event occurs.

Step S307

In contrast, it is determined in Step S305 that the reliability of the coordinates (xᵢ, yᵢ) which configure the predicted track is low, and the predicted track depiction processing is stopped in Step S307.

In such a case, no predicted track is depicted.

Step S308

Steps S304 to S308 correspond to loop processing of repeating the processing in accordance with the reliability index values of the respective coordinate positions for i=0 to n corresponding to the coordinates which configure the predicted track. If the processing is completed on all the coordinate positions for i=0 to n, the processing proceeds to Step S309.

Step S309

In Step S309, it is determined whether or not the next event has been input. If no input of the next event is detected, the processing is completed. If an input of the next event is detected, the processing proceeds to Step S310.

Step S310

In Step S310, coordinate information corresponding to the newly input event is acquired. The processing is performed as processing of detecting time (or a frame)=t and information on pen contact position coordinates (x, y) corresponding to the time in the same manner as in Step S301. Thereafter, the processing in Step S302 and the following steps are repeated based on the coordinate information corresponding to the newly input event.

Next, a description will be given a display control sequence for executing predicted track depiction control in accordance with a value of pressure of the input device or the like, in addition to the aforementioned processing examples 1 to 3, with reference to the flowchart shown in FIG. 24.

Step S401

First, in Step S401, an input event by the input device is detected. Specifically, processing of detecting a touch position of a dedicated pen, for example, with respect to the input display unit is performed. The processing is performed as processing of detecting the time (or the frame)=t and the information on the pen contact position coordinates (x, y) corresponding to the time, and further, as processing of detecting the value of pressure p.

Step S402

The information processing apparatus depicts a track to be displayed on the display unit by applying the event information input in Step S401. However, a region where the depiction processing corresponding to the actual track of the pen does not catch up, namely the depiction delay region 23 as described above with reference to FIG. 1 is generated as described above. In order to depict the predicted track in the depiction delay region, the learning processing using the track information of the past depicted track is performed.

That is, the learning processing for estimating the predicted track is performed in accordance with the processing as described above with reference to FIGS. 5 to 8, for example. Specifically, the processing of detecting the similar tracks, which are similar to the last track 82 including the newest depiction position 81 of the depicted track 80, from the depicted track 80 and the like is executed as shown in FIG. 6. In Step S402, the learning processing including the similar track detection is executed.

Step S403

In Step S403, the predicted track estimation processing by using the similar regions which are detected in Step S402 is executed. As a procedure of the predicted track estimation processing, the processing of calculating k coordinates corresponding to the future frame u, which are estimated in accordance with the plurality of (k) similar tracks, and obtaining an average position of the k coordinates as coordinates which configure the predicted track in the frame u is performed.

If it is assumed that future frames up to the n-th point are prediction targets, coordinates which configure the predicted tracks and the reliability index values SD for the respective predicted coordinates are individually calculated. That is, (x₀, y₀, sd₀) to (xₙ, yₙ, sdₙ) are calculated. Here, a setting is employed in which a variable corresponding to the predicted future frame number is i and n+1 coordinate positions and the reliability index values are calculated for i=0 to n.

Step S404

Steps S404 to S408 correspond to loop processing of repeating the processing in accordance with the reliability index values of the respective coordinate positions for i=0 to n corresponding to the coordinates which configure the predicted track. In addition, the reliability index values SD are values corresponding to standard deviations σ of the plurality of estimated coordinate in the respective future frames, which are calculated based on the plurality of similar tracks, as described above with reference to FIG. 12 and the like.

Step S405

In Step S405, a reliability index value SD[i] of coordinates (xᵢ, yᵢ) which configure the predicted track is compared with the threshold value (α×s). As described above with reference to FIG. 18 and the like, α is a preset coefficient, and s represents a track moving distance s in a frame of the last track 161 as shown in FIG. 18.

In Step S405, it is determined whether or not the determination equation SD[i]<α×s is satisfied. If the above determination equation is satisfied, the coordinates (xᵢ, yᵢ) which configure the predicted track mean that a standard deviation σ of the plurality of predicted coordinate positions calculated in accordance with the plurality of similar tracks as calculation sources is small, that is, the coordinates (xᵢ, yᵢ) mean that distribution of the plurality of predicted coordinate positions is small. In such a case, it is determined that the reliability of the coordinates (xᵢ, yᵢ) which configure the predicted track is high, and the processing proceeds to Step S406.

In contrast, if the above determination equation is not satisfied, the coordinates (xᵢ, yᵢ) which configure the predicted track mean that the standard deviation σ of the plurality of predicted coordinate positions calculated in accordance with the plurality of similar tracks as calculation sources is large, that is the coordinates (xᵢ, yᵢ) mean that the distribution of the plurality of predicted coordinate positions is large. In such a case, it is determined that the reliability of the coordinates (xᵢ, yᵢ) which configure the predicted track is low, and the processing proceeds to Step S407.

Step S406

If it is determined in Step S405 that the reliability of the coordinates (xᵢ, yᵢ) which configure the predicted track is high, the predicted track depiction processing is executed in Step S406. Here, the predicted track is depicted in a different manner from that of the depicted track corresponding to the actual track. That is, the predicted track is depicted and displayed in a state where at least one of the color, the transparency, and the thickness is set differently from that of the depicted actual track as described above with reference to FIGS. 13 and 14.

In addition, a configuration is also applicable in which at least one of the color, the transparency, and the thickness is further changed and displayed in accordance with the reliability as described above with reference to FIGS. 15 and 16. Moreover, the predicted track is sequentially updated and displayed every time a new event occurs.

Step S407

In contrast, it is determined in Step S405 that the reliability of the coordinates (xᵢ, yᵢ) which configure the predicted track is low, the predicted track depiction processing is stopped in Step S407. In such a case, no predicted track is depicted. Alternatively, display control such as blurring for causing the predicted track to appear less outstandingly is executed as described above with reference to FIG. 23.

Step S408

Steps S404 to S408 correspond to loop processing of repeating the processing in accordance with the reliability index values of the respective coordinate positions for i=0 to n corresponding to the coordinates which configure the predicted track. If the processing is completed on all the coordinate positions for i=0 to n, the processing proceeds to Step S409.

Step S409

In Step S409, it is determined whether or not a condition for stopping the predicted track depiction processing has been detected. This corresponds to the processing of determining whether or not the detection state (A) or (B) described above with reference to FIG. 19, for example, has been detected.

That is, this corresponds to detection of one of the following states:

(A) detection of a fact that an amount of decrease in a value of pressure of the input device per a unit time is equal to or greater than the prescribed threshold value [Thp]; or

(B) detection of a fact that a moving amount of the input device per a unit time is less than the prescribed threshold value [Thd].

In Step S409, it is determined whether or not one of (A) and (B), for example, has been detected.

If it is determined in Step S409 that one of (A) and (B) has been detected, the processing proceeds to Step S410.

If it is determined that neither (A) nor (B) has been detected, the processing proceeds to Step S411. Step S410

If it is determined in Step S409 that one of (A) and (B) has been detected, the predicted track depiction is stopped in Step S410.

The processing corresponds to the processing described above with reference to FIGS. 19 to 21. After the processing, the processing proceeds to Step S411.

Step S411

In Step S411, it is determined whether or not the next event has been input.

If no input of the next event is detected, the processing is completed.

If an input of the next event is detected, the processing proceeds to Step S412.

Step S412

In Step S412, the coordinate information corresponding to the newly input event is acquired. The processing is performed as processing of detecting the time (or the frame)=t and the information on the pen contact position coordinates (x, y) corresponding to the time, and further, as processing of detecting the value of pressure p in the same manner as in Step S401.

Thereafter, the processing in Step S402 and the following steps are repeated based on the coordinate information corresponding to the newly input event.

9. Concerning Example of Effects by Precise Predicted Track Display

By applying the aforementioned processing according to the present disclosure, it is possible to precisely display the track of the input device such as a dedicated pen.

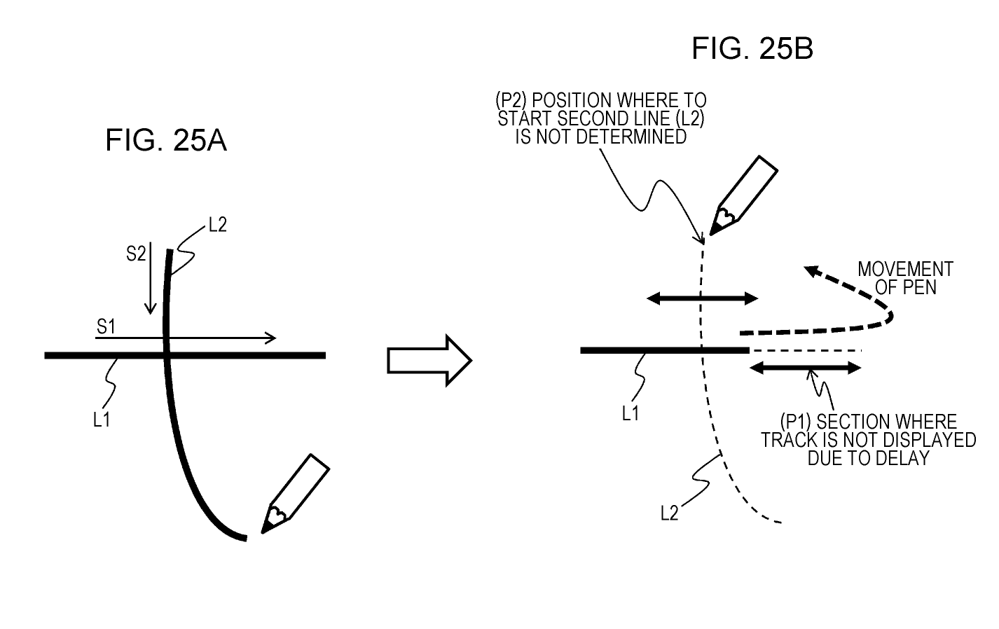

A description will be given of an example of effects that can be achieved by executing the processing, with reference to FIGS. 25A and 25B. For example, a case where a specific character is depicted in accordance with Steps S1 and S2 as shown in FIG. 25A will be considered.

First, in Step S1, a horizontal line L1 is written. Thereafter, in Step S2, a line L2 in the vertical direction is written. It is assumed to be necessary to write the line L2 as a line which passes through substantially the center of the line L1.

However, if the track depiction is delayed as shown in FIG. 25B, for example, a line segment at the end of the horizontal line L1 is not displayed for a predetermined period of time after the user writes the horizontal line L1 as shown by (P1) in the drawing. If the user attempts to start to write the line L2 in the vertical direction in such a state, it is difficult for the user to correctly recognize the center of the horizontal line L1. Accordingly, a problem in which it is difficult for the user to determine where to start L2 occurs as shown by (P2) in FIG. 25B.

Such a problem is solved and the user can smoothly perform the processing by executing precise depiction of the predicted track, to which the processing according to the present disclosure is applied.

10. Concerning Hardware Configuration Example of Information Processing Apparatus According to Present Disclosure

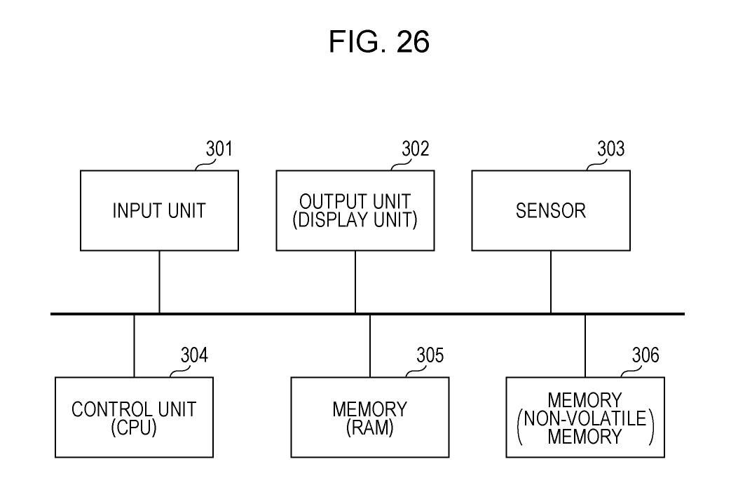

Next, a description will be given of a hardware configuration example of the information processing apparatus according to the present disclosure with reference to FIG. 26.

As shown in FIG. 26, the information processing apparatus includes an input unit 301, an output unit (display unit) 302, a sensor 303, a control unit (CPU or the like) 304, a memory (RAM) 305, and a memory (non-volatile memory) 306.

The input unit 301 is configured as an input unit which has a touch panel function and also functions as a display unit, for example. However, the touch panel function is not necessarily provided, and any configuration is applicable as long as a configuration for inputting information on detected movement of the input device is provided.

As the input device, it is possible to use a dedicated pen or a finger of the user. In addition, a configuration is also applicable in which information on movement of a device such as a gyro pointer is input. Furthermore, a configuration is also applicable in which a camera is provided as the input unit 301 and detected user movement (gesture and the like) is used as input information.

In addition, a mouse provided in a general PC may be set as the input device. Moreover, the input unit 301 is configured not only of the function for inputting the information on the movement of the input device but also of an input unit which performs various settings such as luminance adjustment for the display unit 302 and a mode setting.

The output unit 302 is configured of a display unit or the like which displays track information in accordance with the information on the movement of the input device, which is detected by the input unit 301. For example, the output unit 302 is a touch panel-type display.

The sensor 303 is a sensor for inputting information to be applied to the processing according to the present disclosure, and for example, the sensor 303 is a sensor for detecting pressure of the touch pen or a sensor for detecting an area pressurized by the finger.

The control unit 304 is a CPU or the like which is configured of an electronic circuit, for example, and functions as the data processing unit which executes the processing in accordance with the flowcharts described above in the embodiments.

The memory 305 is a RAM, for example, and is used as a work area for executing the processing in accordance with the flowcharts described above in the embodiments and as a storage region for storing the information on the position of the input device used by the user and various parameters to be applied to the data processing.

The memory 306 is a non-volatile memory and is used as a storage region which stores a program for executing the processing in accordance with the flowcharts described above in the embodiments, tracks depicted by the user, and the like.

Although the above description was given of the embodiments in which k Nearest Neighbors (kNN) method was applied to the learning processing for calculating the predicted track, the learning processing for estimating the predicted track according to the present disclosure is not limited to the kNN, and another method may be applied. For example, the following methods can be applied:

a linear regression method;

a Support Vector Regression (SVR) method;

a Relevant Vector Regression (RVR) method; or

a Hidden Markov Model (HMM) method.

Furthermore, the prediction technology disclosed in Japanese Unexampled Patent Application Publication No. 2011-118786 previously filed by the present applicant may be applied.

In addition, the information processing apparatus according to the present disclosure may be configured to be integrated with the display apparatus which displays the track, or may be separately configured as an apparatus capable of communicating with the display apparatus. In addition, the information processing apparatus may be a server capable of performing data communication via a network, for example. In such a case, input information by the input device which is operated by the user is transmitted to the server, and the server executes predicted track calculation based on the aforementioned learning processing. Furthermore, the server executes processing of transmitting the calculation result to the display apparatus on the user side, such as a tablet terminal, and displaying the predicted track on the display unit of the tablet terminal.

11. Conclusion of Configuration According to Present Disclosure

As described above, the embodiments according to the present disclosure were described in detail with reference to specific embodiments. However, it is obvious that those skilled in the art can employ amendments and replacements of the embodiments without departing from the gist of the present disclosure. That is, the present disclosure was described for an illustrative purpose and was not intended to be exclusively interpreted. It is necessary to take claims into consideration in order to determine the gist of the present disclosure.

In addition, the technologies described herein can be configured as follows:

(1) An information processing apparatus including: a data processing unit which performs track calculation processing in accordance with input position information, wherein the data processing unit executes predicted track calculation processing for calculating a predicted track of a region for which the track calculation in accordance with the input position information has not been completed, and calculates the predicted track by using a dynamic prediction method in the predicted track calculation processing.

(2) The information processing apparatus according to (1), wherein the dynamic prediction method is a method of performing track prediction to which track information previous to the last track of a depicted track is applied.

(3) The information processing apparatus according to (1) or (2), wherein in the predicted track calculation processing, a plurality of similar tracks which are similar to the last track immediately before the region for which the predicted track is to be calculated are detected from the past track, and the predicted track is calculated based on the detected plurality of similar tracks.

(4) The information processing apparatus according to (3), wherein in the predicted track calculation processing, following tracks of the respective similar tracks are estimated based on the detected plurality of similar tracks, and the predicted track is calculated by averaging processing or weighted addition processing of the estimated plurality of following tracks.

(5) The information processing apparatus according to (3) or (4), wherein in the processing of detecting the similar tracks which are similar to the last track, the data processing unit compares feature amounts of tracks and selects track regions with feature amounts which are similar to that of the last track as similar tracks.

(6) The information processing apparatus according to (5), wherein the feature amount includes at least one of a speed, acceleration, an angle, and an angular difference of the track.

(7) The information processing apparatus according to (5), wherein the feature amount includes all the speed, the acceleration, the angle, and the angular difference of the track.

(8) The information processing apparatus according to any one of (5) to (7), wherein the feature amount includes at least one of a value of pressure, which is a pressure of writing by an input device, and an amount of variation in the value of pressure.

(9) The information processing apparatus according to any one of (5) to (8), wherein the feature amount includes all the speed, the acceleration, the angle, the angular difference, and the value of pressure of the track.

(10) The information processing apparatus according to any one of (3) to (9), wherein in the processing of detecting the similar tracks which are similar to the last track, the data processing unit calculates, as feature amount distance data, weighted addition data of differences between speeds, acceleration, angles, and angular differences of the last track and of comparison target tracks in the past, and selects tracks in the past, which have small feature amount distance data, as similar tracks.

(11) The information processing apparatus according to (10), wherein in the feature amount distance data calculation processing in the processing of detecting the similar tracks which are similar to the last track, the data processing unit executes the feature amount distance data calculation processing in which a weight in accordance with a distance is set such that tracks which are close to the last track, in terms of the distance therefrom, are selected with priority.

(12) The information processing apparatus according to any one of (4) to (11), wherein in the processing of estimating the following tracks of the respective similar tracks based on the plurality of similar tracks, the data processing unit estimates speeds, angles, and coordinates of the following tracks corresponding to the respective similar tracks by applying information on speeds, angles, and coordinate positions of the newest positions of the respective similar tracks, and calculates coordinates which configure the predicted track by averaging processing or weighted addition processing of the estimated coordinates of the following tracks corresponding to the respective similar tracks.

(13) The information processing apparatus according to (12), wherein in the weighted addition processing of the estimated coordinates of the following tracks corresponding to the respective similar tracks, the data processing unit calculates the coordinates which configure the predicted track by executing processing in which a weight for coordinates of a following track corresponding to a similar track with higher similarity with respect to the last track is set to be larger.

(14) The information processing apparatus according to any one of (4) to (13), wherein the data processing unit calculates reliability of the predicted track in accordance with a degree of distribution in the estimated coordinates of the following tracks corresponding to the respective similar tracks, and in a case where the reliability is determined to be low, stops an output of the predicted track to a display unit.

(15) The information processing apparatus according to (14), wherein the data processing unit calculates standard deviation of the coordinates of the following tracks corresponding to the respective similar tracks as an index value of the reliability.

(16) The information processing apparatus according to any one of (1) to (15), wherein the data processing unit executes predicted track estimation processing to which a k nearest neighbors (kNN) method is applied.

(17) The information processing apparatus according to any one of (1) to (16), wherein in the predicted track calculation processing, the data processing unit calculates the predicted track based on information of a track which is depicted before a track being currently displayed.

(18) An information processing method which is executed by an information processing apparatus including a data processing unit which performs track calculation processing in accordance with input position information, the method including: causing the data processing unit to execute predicted track calculation processing for calculating a predicted track of a region for which the track calculation in accordance with the input position information has not been completed; and calculating the predicted track by using a dynamic prediction method in the predicted track calculation processing.

(19) A program which causes an information processing apparatus to execute information processing, the program including: causing a data processing unit to execute track calculation processing in accordance with input position information; causing the data processing unit to execute predicted track calculation processing for calculating a predicted track of a region for which the track calculation in accordance with the input position information has not been completed; and calculating the predicted track by using a dynamic prediction method in the predicted track calculation processing.

In addition, the series of processing described herein can be executed by hardware, software, or a composite configuration of both the hardware and the software. In a case of executing the processing by the software, it is possible to install a program, which records the processing sequence, on a memory in a computer embedded in dedicated hardware and to cause the computer to execute the program, or to install the program on a general-purpose computer capable of executing various kinds of processing and to cause the computer to execute the program. For example, the program can be recorded in a recording medium in advance. The program can be installed on the computer from the recording medium or be received via a network including a local area network (LAN) and the Internet and installed in a built-in recording medium such as a hard disk.

In addition, the various kinds of processing described herein may be executed in a time series manner in accordance with the description or may be executed in parallel or individually as necessary in accordance with processing capability of the apparatus which executes the processing. In addition, the system described herein is a logical composite configuration of a plurality of apparatuses, and the apparatuses with the respective configurations are not necessarily provided in the same case body.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a data processing unit which performs track calculation processing in accordance with input position information,
wherein the data processing unit executes predicted track calculation processing for calculating a predicted track of a region for which the track calculation in accordance with the input position information has not been completed, and calculates the predicted track by using a dynamic prediction method in the predicted track calculation processing.

2. The information processing apparatus according to claim 1,
wherein the dynamic prediction method is a method of performing track prediction to which track information previous to the last track of a depicted track is applied.

3. The information processing apparatus according to claim 1,
wherein in the predicted track calculation processing, a plurality of similar tracks which are similar to the last track immediately before the region for which the predicted track is to be calculated are detected from the past track, and the predicted track is calculated based on the detected plurality of similar tracks.

4. The information processing apparatus according to claim 3,
wherein in the predicted track calculation processing, following tracks of the respective similar tracks are estimated based on the detected plurality of similar tracks, and the predicted track is calculated by averaging processing or weighted addition processing of the estimated plurality of following tracks.

5. The information processing apparatus according to claim 3,
wherein in the processing of detecting the similar tracks which are similar to the last track, the data processing unit compares feature amounts of tracks and selects track regions with feature amounts which are similar to that of the last track as similar tracks.

6. The information processing apparatus according to claim 5,
wherein the feature amount includes at least one of a speed, acceleration, an angle, and an angular difference of the track.

7. The information processing apparatus according to claim 5,
wherein the feature amount includes all the speed, the acceleration, the angle, and the angular difference of the track.

8. The information processing apparatus according to claim 5,
wherein the feature amount includes at least one of a value of pressure, which is a pressure of writing by an input device, and an amount of variation in the value of pressure.

9. The information processing apparatus according to claim 5,
wherein the feature amount includes all the speed, the acceleration, the angle, the angular difference, and the value of pressure of the track.

10. The information processing apparatus according to claim 3,
wherein in the processing of detecting the similar tracks which are similar to the last track, the data processing unit calculates, as feature amount distance data, weighted addition data of differences between speeds, acceleration, angles, and angular differences of the last track and of comparison target tracks in the past, and selects tracks in the past, which have small feature amount distance data, as similar tracks.

11. The information processing apparatus according to claim 10,
wherein in the feature amount distance data calculation processing in the processing of detecting the similar tracks which are similar to the last track, the data processing unit executes the feature amount distance data calculation processing in which a weight in accordance with a distance is set such that tracks which are close to the last track, in terms of the distance therefrom, are selected with priority.

12. The information processing apparatus according to claim 4,
wherein in the processing of estimating the following tracks of the respective similar tracks based on the plurality of similar tracks, the data processing unit estimates speeds, angles, and coordinates of the following tracks corresponding to the respective similar tracks by applying information on speeds, angles, and coordinate positions of the newest positions of the respective similar tracks, and calculates coordinates which configure the predicted track by averaging processing or weighted addition processing of the estimated coordinates of the following tracks corresponding to the respective similar tracks.

13. The information processing apparatus according to claim 12,
wherein in the weighted addition processing of the estimated coordinates of the following tracks corresponding to the respective similar tracks, the data processing unit calculates the coordinates which configure the predicted track by executing processing in which a weight for coordinates of a following track corresponding to a similar track with higher similarity with respect to the last track is set to be larger.

14. The information processing apparatus according to claim 12,
wherein the data processing unit calculates reliability of the predicted track in accordance with a degree of distribution in the estimated coordinates of the following tracks corresponding to the respective similar tracks, and in a case where the reliability is determined to be low, stops an output of the predicted track to a display unit.

15. The information processing apparatus according to claim 14,
wherein the data processing unit calculates standard deviation of the coordinates of the following tracks corresponding to the respective similar tracks as an index value of the reliability.

16. The information processing apparatus according to claim 1,
wherein the data processing unit executes predicted track estimation processing to which a k nearest neighbors (kNN) method is applied.

17. The information processing apparatus according to claim 1,
wherein in the predicted track calculation processing, the data processing unit calculates the predicted track based on information of a track which is depicted before a track being currently displayed.

18. An information processing method which is executed by an information processing apparatus including a data processing unit which performs track calculation processing in accordance with input position information, the method comprising:
causing the data processing unit to execute predicted track calculation processing for calculating a predicted track of a region for which the track calculation in accordance with the input position information has not been completed; and
calculating the predicted track by using a dynamic prediction method in the predicted track calculation processing.

19. A program which causes an information processing apparatus to execute information processing, the program comprising:
causing a data processing unit to execute track calculation processing in accordance with input position information;
causing the data processing unit to execute predicted track calculation processing for calculating a predicted track of a region for which the track calculation in accordance with the input position information has not been completed; and
calculating the predicted track by using a dynamic prediction method in the predicted track calculation processing.
